(19) United States
(12) Patent Application Publication
(10) Pub. No.: US 2026/0087329 A1
(43) Pub. Date: Mar. 26, 2026

(54) PERSISTENT FIXED-SIZE MEMORY FOR MACHINE-LEARNING USING RECURRENT NEURAL NETWORKS

(71) Applicant: Londeree Technologies LLC, Worthington, OH (US)

(72) Inventor: Alex Bryan Londeree, Worthington, OH (US)

(73) Assignee: Londeree Technologies LLC, Worthington, OH (US)

(21) Appl. No.: 19/333,279

(22) Filed: Sep. 18, 2025

Related U.S. Application Data
(60) Provisional application No. 63/697,045, filed on Sep. 20, 2024.

(51) Int. Cl. G06N 3/048; G06N 3/044

(52) U.S. Cl. CPC G06N 3/048; G06N 3/044

(57) ABSTRACT

Computer-implemented methods and systems provide a persistent fixed-size recurrent memory that supports long or unbounded sequence processing with substantially constant compute and bounded memory. A recurrent model maintains a matrix state updated per chunk from key, value, gate, and optional control signals; a gated error between value and a key-weighted state yields a rank-1 proposal. Chunk proposals are reconciled coordinate-wise by an order-invariant convex combiner; solitary proposals pass unchanged. Queries can be answered from proposals without materializing a full updated state. Multiple asynchronous agents emit sparse updates with overwrite strengths that are merged using sparse convex or max selection and optional optimizer preprocessing. A feedback projection writes higher layer activations into lower layer state to consolidate durable skills and reduce forgetting. The approach enables durable retention, parallel inference-time adaptation, scalable linear-attention approximation, and persistent fixed memory use over arbitrarily long sequences.

### BACKGROUND

### Field of the Disclosure

The present disclosure relates generally to artificial intelligence (AI)/machine learning (ML) computer systems and, more particularly, to computer systems and computer-implemented methods for persistent fixed-size memory for ML using recurrent neural networks (RNNs).

### DESCRIPTION OF THE RELATED ART

Data processing and computer science have seen a revolution in learning and memory algorithms with the advent of “cognitive computing”: technologies in data and signal processing that harness many of the same capabilities as the human brain. Recent advancements in artificial intelligence (AI) and machine learning (ML) have ushered in a new era that promises to further develop and improve the performance of computer systems for interaction with human users. In particular, AI/ML technology has advanced to a level such that certain available AI/ML models can independently interact with humans and can also generate content that realistically mimics content generated by humans. The content generation ability of such available AI/ML models includes conversational chat output, written text on nearly any given topic, computer code, voice audio, along with images and video content. In some cases, the content generation ability of such available AI/ML models can attain or exceed professional levels of human content, even in specialized domains such as law and science, among others.

The underlying methodology of AI/ML technology has been based on neural network (NN) implementations to generate desired output. However, even the largest and most advanced available AI/ML models based on NNs may still lack desired characteristics.

### BRIEF DESCRIPTION OF THE DRAWINGS

For a more complete understanding of the present disclosure and its features and advantages, reference is now made to the following description, taken in conjunction with the accompanying drawings, in which:

FIGS. 1 and 2 illustrate data structures associated with AI/ML methods, in exemplary embodiments;

FIGS. 3 and 4 schematically depict linear algebra operations that operate on tensors, in exemplary embodiments;

FIG. 5 schematically depicts a tensor dot product and a tensor cross product, in one embodiment;

FIG. 6 depicts an AI/ML architecture, in one embodiment;

FIG. 7 depicts an ML model, in one embodiment;

FIG. 8 depicts an implementation of an RNN layer, in one embodiment;

FIG. 9 depicts certain elements of language token embedding, in one embodiment;

FIG. 10 is a schematic depiction of a computer system, in one embodiment;

FIG. 11 is a schematic depiction of a high-performance computing (HPC) cluster, in one embodiment;

FIG. 12 is a flow chart of a method for training an ML model, in one embodiment; and

FIG. 13 is a depiction of a parallel RNN process using agents, in one embodiment.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted, AI/ML models based on NN implementations have been developed at very large scale and have demonstrated remarkable results that have received widespread public appreciation. Whether or not such AI/ML models have achieved so-called “true intelligence” resembling the sentient performance of living neural systems, recently developed large AI/ML models have attained remarkable advances in data processing performance. Some examples of advanced AI/ML models that have been recently released include large language models (LLMs) that are capable of natural language processing (NLP) in text and voice speech, and so-called vision transformers (ViT) that employ similar architectures for representation and processing of image and video data.

Such achievements in data processing performance have also been made possible by ongoing, commensurately large advances in the underlying performance of semiconductor devices, such as processors, bus interfaces, timing signals, and memory devices, among others, that provide the data processing performance and are used for modern computer architectures on which the AI/ML models are developed and executed. Other advancements in semiconductor device processing and fabrication, such as three-dimensional (3D) hybrid integration, have also facilitated large leaps in computing performance that has enabled presently available AI/ML models to be widely disseminated and broadly used.

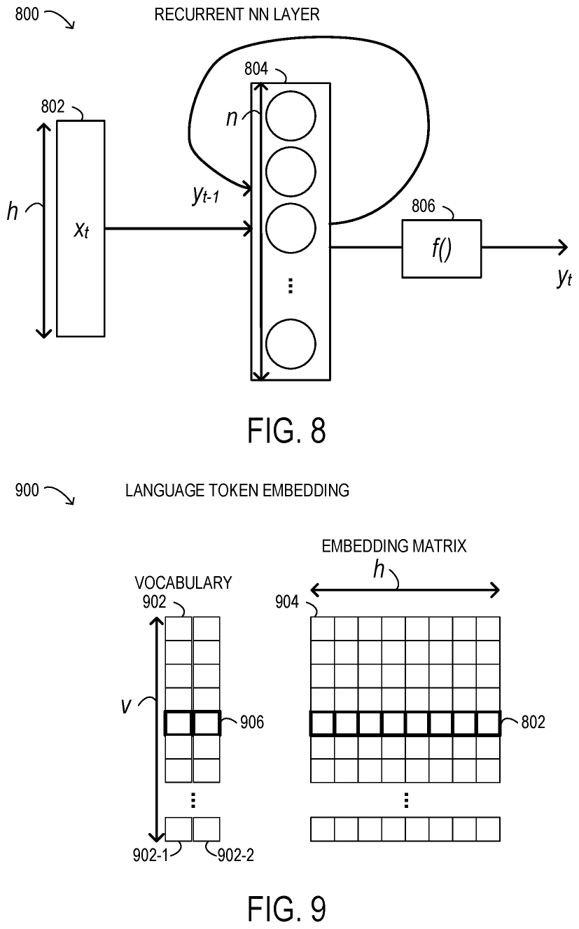

The advances in computing power and data processing have further enabled so-called “timestep execution” of large AI/ML models (or simply “model”), in which repeated (or looped) execution of a model is performed according to a time base in a continuous manner. One period of the time base may comprise a timestep, such that at each timestep, the model and associated data structures have a given input state and an output state. The input state for a timestep can be previously initialized. The output state can be calculated by the model, in addition to certain other information. In some embodiments, a new output state can be a partial update to a prior output state. Further details of data recurrency as processed by an RNN, for example, are described below with respect to FIG. 8.

One example of such recent large AI/ML models, among others, used in timestep execution are LLMs based on NN architectures. Various LLMs have been released for public use and have been promulgated for use in many application domains of computer and software technology. LLMs have been used in application domains where human-to-machine interaction is involved, such as chat engines and synthetic conversational voice generators, also referred to as “AI voice generators”, among other examples.

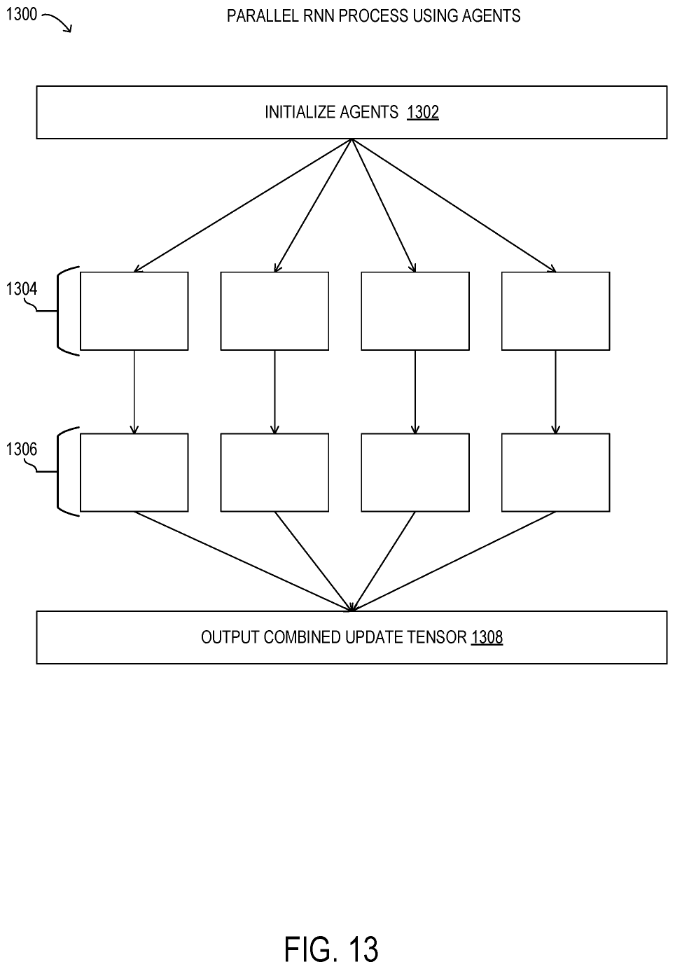

Certain implementations may employ multiple AI/ML models, each referred to herein as an “agent”, each of which can process data and be updated by learning. In some instances, multiple inferences can be made by different agents to the same data, resulting in multiple updates to that same data by different agents. In various cases of action by multiple agents, such as during one timestep, the output may be combined and synthesized in a variety of ways as further described with respect to FIG. 13.

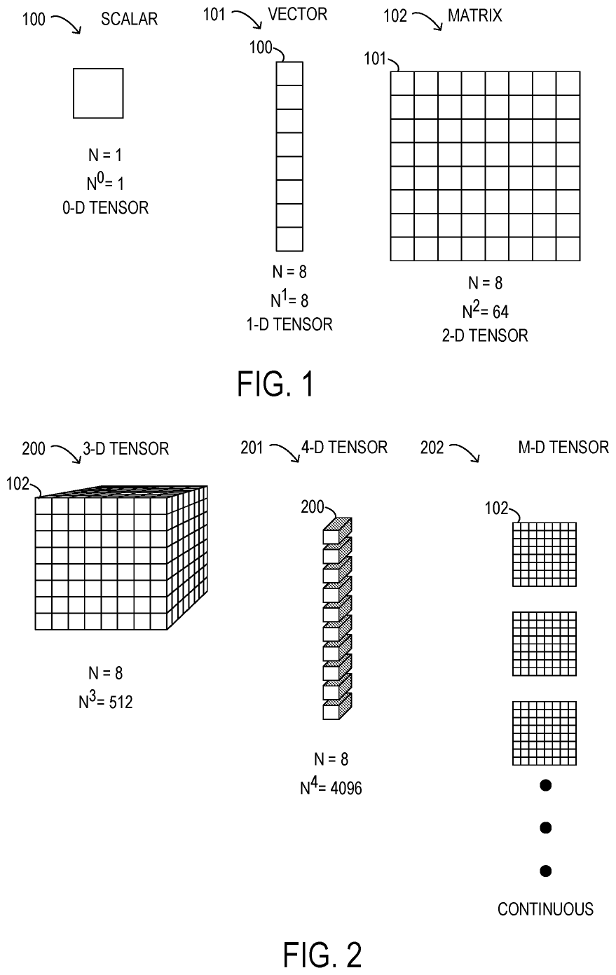

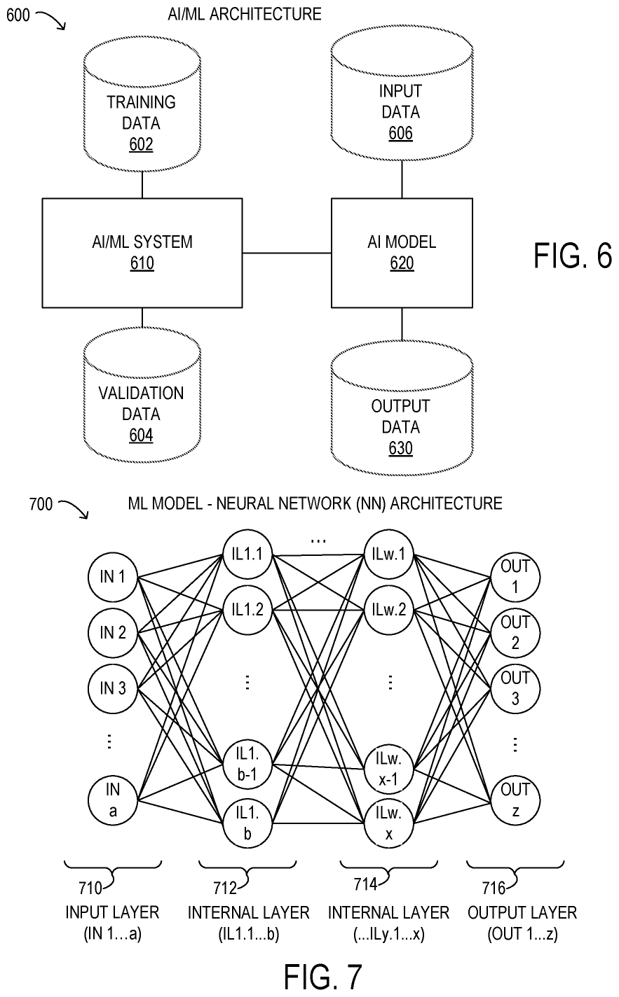

In the following description, basic concepts involved with NNs, including data structures and linear algebra, are first introduced and presented, with respect to FIGS. 1-5. Then, in FIGS. 6-9, core aspects of NN implementations are discussed, including RNN implementations in timestep execution for use with LLMs.

Referring now to the drawings, FIGS. 1 and 2 illustrate data structures associated with AI/ML methods in increasing order of dimensionality. The square or box elements depicted in FIGS. 1 and 2 represent numerical values, such as Boolean or integer or real number values that can be stored in a computer memory in digital form. The numerical values depicted in FIGS. 1 and 2 may be stored in various levels of resolutions (e.g., number of bits per value)

for different degrees of accuracy. Also shown in FIGS. 1 and 2 are different values for a dimensional value N associated with a respective data structure, as will be described in further detail. In particular, symmetric examples of higher order data structures are shown in FIGS. 1 and 2 for descriptive clarity, such that a single value of N can be used to characterize the dimensions of the respective data structure. It is noted that, in different embodiments, asymmetric data structures having different dimensional lengths can be used.

Also shown in FIGS. 1 and 2 with each respective drawing is a tensor order designation (also referred to as a dimension or a “rank” of a tensor) for each respective data structure. As used herein, the term “tensor” refers to a data structure as defined and used in the context of AI/ML methods, and in particular, for various types of NN implementations of AI/ML methods, also referred to as “deep learning”. A tensor data structure is typically used to represent an input data structure, an output data structure, and various transformation operations in data processing associated with NNs. Therefore, tensor data structures are typically used for programming software code to implement NNs. As shown in FIGS. 1 and 2 and described below, tensor data structures can provide a uniform or generalized representation of different order data structures used in NN implementations.

In FIG. 1, a scalar value 100 is shown as a single element representing a single numerical value. A value of N=1 is associated with scalar value 100, indicating a single value. Scalar value 100 can serve as a fundamental element in higher order data structures with respect to FIGS. 1 and 2 and described subsequently below. Also shown with scalar value 100 is a designation as a 0-D tensor, such that N=1, corresponding to one scalar value 100, and which describes an order or degree of scalar value 100 (e.g., zero order).

Each scalar value may be stored as one of a number of data types which introduce storage allocation costs and provide a range of values. Some scalar values may have a “null” or “zero” value reflecting a lack of data being stored for that scalar. For non-null scalar values, the overall magnitude of the data that can be held as each element will depend on the data type and any limits to storage and/or processing. Various controls are used in different NN implementations to constrain the magnitudes of these elements.

Next, in FIG. 1, a vector 101 is shown as an array of scalar values 100. In various contexts, vector 101 is accordingly referred to as a 1-D array. A length of vector 101 N is shown in an exemplary embodiment in FIG. 1 as N=8, for descriptive clarity in the present examples. It is noted that N can have any integer value and can be a very large value in some embodiments. Also shown with vector 101 is a designation as a 1-D tensor, such that N\hat{ }2=8, corresponding to a number of scalar values 100 in vector 101, and which describes an order or degree of vector 101 (e.g., first order).

Finally, in FIG. 1, a matrix 102 is shown as an array of vectors 101. In various contexts, matrix 102 is accordingly referred to as a 2-D array. Matrix 102 is shown in a symmetric size having 8 vectors 101 each having a length of 8. It is noted that matrix 102 may be asymmetric in other embodiments. Accordingly, a dimension of matrix 102 that is symmetric is given by a single number, N, shown in an exemplary embodiment in FIG. 1 as N=8. It is noted that N can have any integer value and can be a very large value in some embodiments. Also shown with matrix 102 is a designation as a 2-D tensor, such that N\hat{ }2=64, corresponding to a number of scalar values 100 in matrix 102, and which describes an order or degree of matrix 102 (e.g., second order).

In FIG. 2, the next higher order data structures are shown that are described with tensor designations. Specifically, in FIG. 2, a 3-D tensor 200 is shown as an array of matrices 102. In various contexts, 3-D tensor 200 is accordingly referred to as a 3-D array. 3-D tensor 200 is shown in a symmetric size having 8 matrices 102 each having a symmetric size of 8×8 or 64 scalar values 100. It is noted that 3-D tensor 200 may be asymmetric in other embodiments. Accordingly, a dimension of 3-D tensor 200 that is symmetric is given by a single number, N, shown in an exemplary embodiment in FIG. 2 as N=8. It is noted that N can have any integer value and can be a very large value in some embodiments. Also shown with 3-D tensor 200 is N\hat{ }3=512, corresponding to a number of scalar values 100 in 3-D tensor 200, and which describes an order or degree of 3-D tensor 200 (e.g., third order).

Also in FIG. 2, a 4-D tensor 201 is shown as an array of 3-D tensors 200. In various contexts, 4-D tensor 201 is accordingly referred to as a 4-D array. 4-D tensor 201 is shown in a symmetric size having 8 3-D tensors 200 each having a symmetric size of 8×8×8 or 512 scalar values 100. It is noted that 4-D tensor 201 may be asymmetric in other embodiments. Accordingly, a dimension of 4-D tensor 201 that is symmetric is given by a single number, N, shown in an exemplary embodiment in FIG. 2 as N=8. It is noted that N can have any integer value and can be a very large value in some embodiments. Also shown with 4-D tensor 201 is N\hat{ }4=4096, corresponding to a number of scalar values 100 in 4-D tensor 201, and which describes an order or degree of 4-D tensor 201 (e.g., fourth order).

Finally in FIG. 2, an M-D tensor 202 (also commonly referred to as an “N-D tensor” when N is used as a dimension variable) is shown as a continuous array of 2-D tensors 102, such that M continuously increases. For example, as shown, M-D tensor 202 can represent an example of a sequence of 2-D data, such as image data, that in succession can represent an ongoing video stream, in which each 2-D tensor 102 represents an image frame of the video stream. In various embodiments, M-D tensor 202 can have 0-D tensor 100, 1-D tensor 101, 3-D tensor 200, 4-D tensor 201, or another dimensioned tensor, as array elements, to ultimately define a continuous stream of scalar values 100.

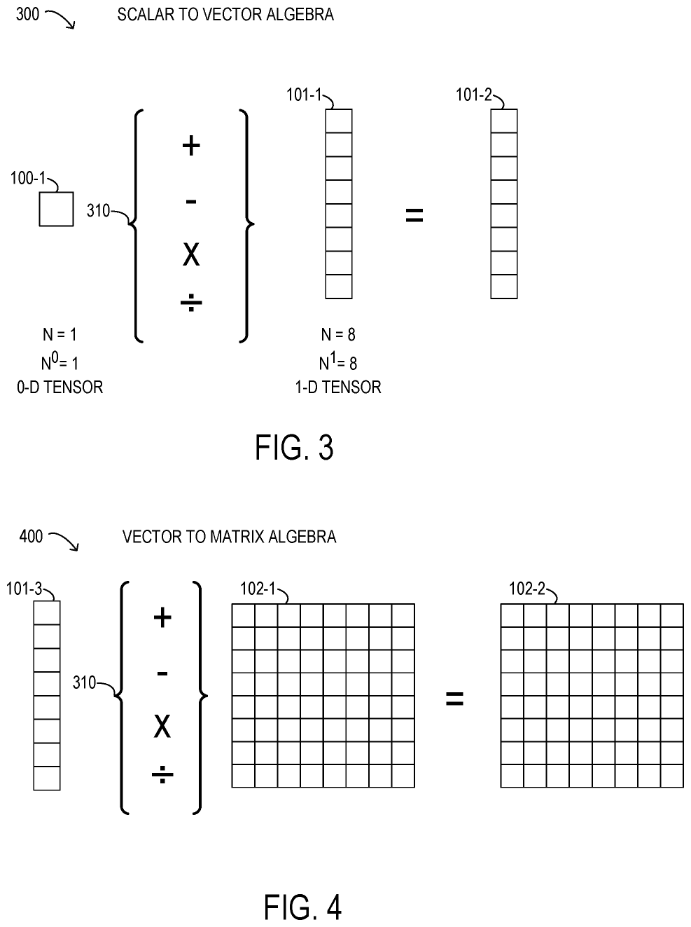

FIGS. 3 and 4 schematically depict linear algebra operations that operate on tensors. In FIG. 3, a scalar to vector algebra operation 300 (or simply, operation 300) is depicted. Specifically in operation 300, a 0-D tensor 100-1 can algebraically operate on a 1-D tensor 101-1 to result in another 1-D tensor 101-2. As shown, operation 300 includes an algebra operation 310 selected from addition, subtraction, multiplication, or division. In certain embodiments, the order of operands 0-D tensor 100-1 and 1-D tensor 101-1 may be reversed. When algebra operation 310 is applied to 0-D tensor 100-1, 0-D tensor 100-1 is replicated to operate on each element in 1-D tensor 101-1. In FIG. 4, a vector to matrix algebra operation 400 (or simply, operation 400) is depicted. Specifically in operation 400, a 1-D tensor 101-3 can algebraically operate on a 2-D tensor 102-1 to result in another 2-D tensor 102-2. As shown, operation 400 includes algebra operation 310, while the order of operands 1-D tensor 101-3 and 2-D tensor 102-1 may be reversed. Higher order tensors can also be used as operands in various linear algebra operations in a similar manner.

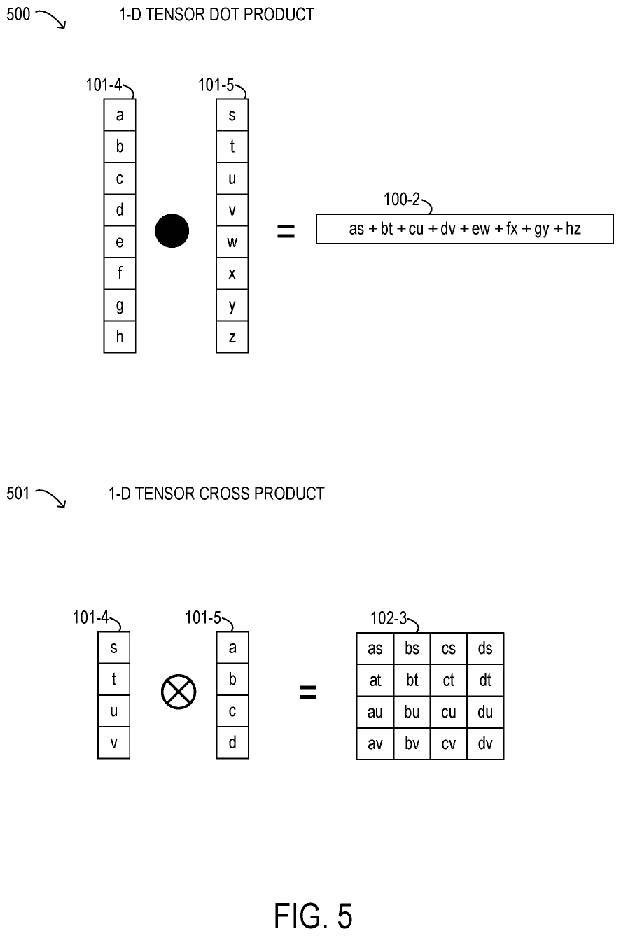

FIG. 5 schematically depicts a tensor dot product and a tensor cross product. A 1-D tensor dot product operation 500 shows a dot product between a 1-D tensor 101-4 and a 1-D tensor 101-5 to result in a 0-D tensor 100-2. The expression shown in 0-D tensor 100-2 indicates how a scalar value for 0-D tensor 100-2 is calculated. Higher order tensors can also be used as operands in dot product operations in a similar manner. A 1-D tensor cross product operation shows a cross product between 1-D tensor 101-4 and 1-D tensor 101-5 to result in a 2-D tensor 102-3. The expressions shown in elements of 2-D tensor 102-3 indicate how individual cross product values for 2-D tensor 102-3 are calculated. Higher order tensors can also be used as operands in cross product operations in a similar manner.

Referring now to FIG. 6, an AI/ML architecture 600 is depicted as a schematic block diagram. AI/ML architecture 600 represents data and functional elements that can be computer-implemented, as described herein. As shown, AI/ML architecture 600 includes an AI/ML system 610 that can train and export an AI model 620 that is usable for transformer operation, as will be described in further detail. Output data 630 can represent content generated by AI model 620 resulting from transformer operation on input data 606.

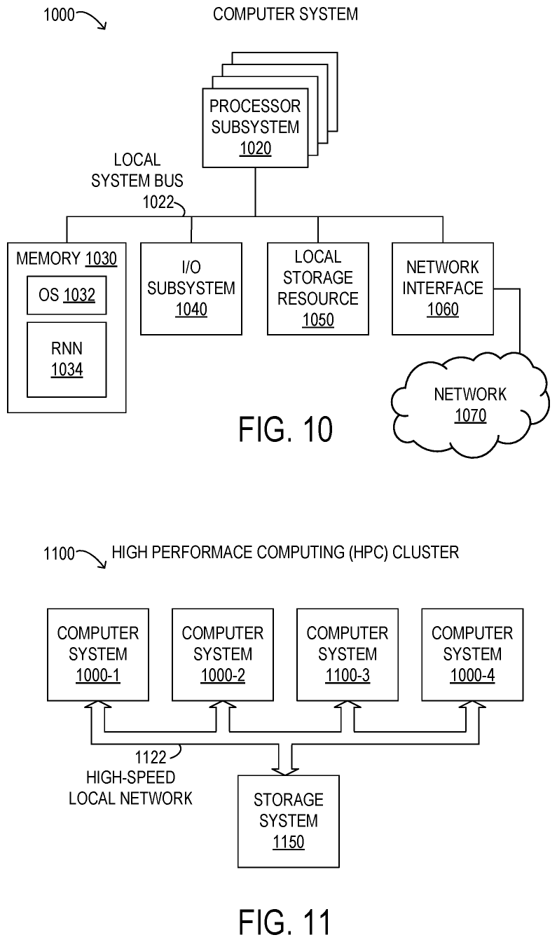

In FIG. 6, AI/ML system 110 can receive training data 602 in order to train AI model 620 for a particular implementation, such as for a particular application executing on a given target computer platform (see also FIGS. 10 and 11). In some implementations, training data 602 may be collected in various forms. In various cases, AI/ML system 610 can use training data 602 to train AI model 620 until a certain condition is met, such as a quality parameter for output data 630 of AI model 620 being within a certain range. In addition to training data 602, AI/ML system 610 can access validation data 604 that can represent reference data that is known or expected to produce a desired result for comparison with training data 602. In this manner, the performance variability of AI model 620 being trained with training data 602 can be validated, such as to within a quality range, using validation data 604.

It is further noted that AI model 620 can include programmable instructions in the form of executable code for a computer processor, such as to implement one or more NNs (see FIG. 7) along with associated functionality. For example, the associated functionality with AI model 620 can include a transformer for performing particular operations on input data 606, such as using various data stored with or generated for use with AI model 620, as will be described in further detail. In different embodiments, a transformer may be specialized to operate with an LLM for NLP, or may be a ViT for image processing.

As shown in FIG. 6, any of training data 602, input data 606, and output data 630 can be stored in various types of memory, including volatile and non-volatile memory that is associated with and accessible by a computer system (see also FIGS. 10 and 11).

FIG. 7 depicts an ML model 700 in one embodiment. ML model 700 is depicted as a neural network architecture having an input layer 710, internal layers 712, 714, and an output layer 716. ML model 700 is a general embodiment that can represent an instance of, or at least certain portions of, AI model 620 to receive input data 606 and generate output data 630 as described above with respect to FIG. 6. ML model 700 can represent at least certain portions of AI/ML system 610 and/or AI model 620. Accordingly, input data 606 can be supplied to ML model 700 as input layer 710, while output data 630 can be obtained from output layer 716, as will be described in further detail below.

In the mathematical processing of ML model 700 of FIG. 7, the processing at each layer can be represented by an activation function that can be generalized by [eq:1].

y=Σᵢ(wᵢxᵢ)+b

In [eq:1], y is an output value, i represents an index variable or dimension for each layer input, such as a, b. x, and z in FIG. 7; xᵢ represents the input value at each neuron, such as from another neuron; Wᵢ represents a weighting coefficient applied at each neuron; and b represents a constant for each neuron. The output of each neuron can be represented by output value y of [eq:1], among other parameters in particular embodiments.

The process of activation of each internal layer as described above and illustrated in FIG. 7 is generally known as feedforward activation, which characterizes the typical use of a neural network to receive input and generate output. Feedforward may occur over multiple timesteps and may involve the use of externally generated data (see “tokens” below), internally generated data, or both. The use of feedforward activation within ML model 700 to generate output (separate from feedback, backpropagation, and other types of training) is also known as “inference”. Accordingly, model learning by the use of inference may be accomplished without the aggregation and computation of information involved with backpropagation that can represent substantially larger amounts of information and computational effort.

In particular, ML model 700 may use deep learning (DL) that can be used to determine higher level highly complex data abstractions with a hierarchical, layered NN architecture to enable learning. ML model 700 may learn by stating, describing, and implementing higher-level, more abstract features on top of lower-level, less abstract features. In this manner, ML model 700

can employ DL to analyze and learn from a large amount of unstructured data that can be unlabeled as well as uncategorized.

It is noted that although ML model 700 is depicted with a certain set of nodes or artificial neurons (referred to herein as simply “neurons”) in FIG. 7, the dimensionality and structure of ML model 700 can be adapted for various specific types of data and applications.

For example, as shown, ML model 700 can be expanded to a number of input neurons, w number of input layers each having b through x number of neurons respectively, and z number of output neurons. It is noted that a, b through x, w, and z can each have different dimensions, such as 10\hat{ }3, 10\hat{ }6, 10\hat{ }9, 10\hat{ }12, among other values in various embodiments. Furthermore, although a single network is shown with ML model 700 in FIG. 7, it is noted that in different implementations, ML model 700 can be structured to incorporate different numbers of networks, such as by implementing a branched or otherwise structured topology.

In order to implement ML model 700 for a given useful application, a training process can be employed to determine respective weighting coefficients applied at each neuron, such as using [eq:1] or another activation function. For example, weighting coefficients associated with neurons in ML model 700 can be represented as a 2-D tensor (e.g., a matrix) that are included in a “network state” of the NN, as explained below.

In the field of NNs and ML, optimization algorithms can be useful for training models by minimizing the error between the predicted output and target values. One known class of optimization algorithms are gradient descent algorithms. Gradient descent can be an iterative optimization algorithm used to minimize a “cost function” (also referred to as a “loss function”), which quantifies an error or a difference between an ML model's prediction and a target value (e.g., a known reference value). The gradient descent can operate by adjusting the parameters of the NN to reduce the error over multiple iterations.

To identify a direction and a magnitude by which model parameters are to be updated, gradients represented by partial derivative of a given model parameter with respect to the cost function, can be computed. For typical feedforward NNs, as shown in ML model 700, the computation of the gradients can be done using so called “backpropagation”, which involves a reverse application of a chain rule to propagate the gradient of the loss function backwards through the NN. In particular embodiments, backpropagation may be used to iteratively train ML model
1. For example, the calculated output of ML model 700 may be represented by output data 630 while the reference output may be represented by validation data 604 (see FIG. 6). The backpropagation method may begin with output layer 716 and then iterate in a reverse manner over internal layer 714, then internal layer 712, to finally arrive at input layer 710.

Because most useful ML models have large numbers of inputs and outputs, backpropagation can be resource intensive. While the calculation of the cost function itself can be relatively simple and fast, calculation of the gradients with respect to the cost function is generally more resource intensive. For some ML models, the runtime of each backpropagation may be greater than the feedforward activation.

FIG. 8 depicts an implementation of an RNN layer 800, in an embodiment. RNN layer 800 is a general depiction of one neural layer in an RNN shown for descriptive clarity. As shown, RNN layer 800 includes a neuron layer 804 having a length n that defines a number of neurons in neuron layer 804. It is noted that various implementations of RNNs may have multiple neural layers, such as corresponding to the NN architecture shown in FIG. 7. Accordingly, as shown in FIG. 8, the text input may be provided to RNN layer 800 in the form of an embedding vector x, 802 having a length h corresponding to the next token being processed from the given input sequence length. Then, embedding vector x, 802 may be multiplied by a weight matrix U having dimensions [h, n] before the results are provided to neuron layer 804. The output of neuron layer 804 may also be provided with input vector yₜ₋₁ back to neuron layer 804. Specifically, input vector yₜ₋₁ may be multiplied by a weight matrix W having dimensions [n, n] before the results are provided to neuron layer 804.

In contrast to feedforward neural networks, introducing recurrency characterizing an RNN may allow for more agile adaptation of the network state when processing data. The network state can include a parameter state of RNN parameters and/or a memory state of memory contents accessed and used during operation of the model, among other information. The network state of the RNN can further include an internal (or “hidden”) state that can represent at least some portions of a memory state used at each timestep, in conjunction with the current input, to generate output. The internal state may then be updated in a “memory step” during a timestep, such that a new internal state is used in the following timestep when the RNN is executed to process data.

In some implementations of an RNN including RNN layer 800, at each timestep, the RNN receives the input state as well as input data for processing. In such RNNs, at least some portions of the input state can be passed from the output state of the previous timestep. Thus, such RNNs can compute a new output state at each timestep that is passed as the input state for the next timestep. The RNN can also generate feedforward output for each timestep.

In particular implementations of RNNs including RNN layer 800, the RNN is included in a class of models referred to as “sequence models” that operate over an input sequence comprising multiple tokens. In such RNNs operating as sequence models, the output state is not necessarily passed to the input state at each timestep. Instead, in RNNs operating as sequence models, the timestep refers to elements within a sequence being processed, such as individual tokens in the sequence. When such RNNs are autoregressive or operated in an autoregressive manner, instead of an input sequence provided externally as input, the RNN itself may generate the input sequence.

As a result of the feedback loop of input vector yₜ₋₁, RNN layer 800 may be capable of retaining information about past timesteps corresponding to previous embedding vectors x, 802 in the input sequence data. Thus, any inference calculations performed by RNN layer 800 may incorporate cumulative information from prior tokens in the input sequence data.

The output of RNN layer 800 may then be used to generate the output vector yₜ for the current timestep, which may correspond to an output token that RNN layer 800 is designed to generate based on one or more previous embedding vectors xₜ 802. For example, for an input sequence length of 3 tokens corresponding to 3 successive timesteps, in one example, the output for yₜ corresponding to an output of RNN layer 800 after 2 tokens (embedding vectors xₜ 802) of the input sequence data may be given by e

$${y}_{t} = f ( {Wy}_{t - 1} + {Ux}_{t} + b )$$

In [eq:2], f( ) corresponds to an activation function 806, while b is a bias term. Activation function 806 may be non-linear, such as a hyperbolic tangent (tanh) function or a rectified linear unit (ReLU) function, among others, in various embodiments. During sequence processing, W, U, and b may remain constant and may be determined using backpropagation after processing an

input sequence. In particular embodiments, the token length of the input sequence that defines a number of timesteps before backpropagation is repeated in RNN layer 800 may be bounded or maintained with a certain range to avoid certain gradient descent errors.

As noted, RNNs may be particularly suited for NLP using an LLM for processing language input. In NLP using an LLM or another language model, the language input may be provided sequentially, such as word-by-word as input sequence data. It is noted that various modalities or media types can be used as input sequence data in different embodiments, such as text, audio (speech or voice), imagery, or video, among various combinations thereof. Accordingly, the language input can generally be a human communication in various modalities. Thus, an RNN having RNN layer 800 may be designed to operate with input sequence data having a given sequence length, for example a sequence length of 3 words in an embodiment. The input sequence data may further be broken down into so-called tokens that represent individual words, symbols, or portions of words (see also FIG. 9). The processing of individual tokens by the RNN to produce an output is referred to as “timestep execution”, in which each timestep corresponds to each successive token generated from the input sequence data being processed by the RNN.

More generally, a token can be a data element or group of data elements that are treated by a NN, such as an RNN including RNN layer 800, as input for processing. A “token” can refer to a generalized description that applies to any structured or unstructured data. In particular embodiments, a token can refer to a unit of data that can be processed by a sequence model, such as a unit of data in the input sequence. A token can accordingly refer to a word in a sentence, a patch of an image, or a time segment in an audio file, among other definitions and used. A token can serve as a primary unit of information that a sequential model operates on, such as during one timestep. In various implementations, a token may be a tensor of any dimensionality and may be externally generated (such as from a human communication) or internally generated (such as during training and/or inference, including in memory update steps, or during autoregression). While tokenization is described below for NLP, various tokenization processes may be used in different applications of a NN, such as an RNN including RNN layer 800.

FIG. 9 depicts certain elements of a language token embedding 900, in an embodiment. As shown in FIG. 9, language token embedding 900 depicts linear algebra operations performed to generate embedding vector x, 802 from a given input token. In language token embedding 900, a vocabulary 902 is defined as a matrix having 2 columns corresponding to two vectors, and having a length v corresponding to a number of tokens in vocabulary 902. Specifically, a first vector 902-1 may include all tokens in vocabulary 902 that are ordered according to a second vector 902-2 that contains v number of incrementing integer index values. It is noted that second vector 902-2 may be implicit by a given order of tokens in first vector 902-1.

In operation of language token embedding 900, an input token 906 is matched with a location in vocabulary 902, shown as bold elements in FIG. 9, corresponding to a row index in an embedding matrix 904 having size [h, v]. Embedding matrix 904 may map tokens to individual rows that contain vectors corresponding to respective individual token embeddings of length h. Thus, in the example of language token embedding 900, input token 906 corresponds to embedding vector xₜ 802, shown and described above with respect to FIG. 8. The embedding vectors stored in embedding matrix 904, corresponding to vocabulary 902, may accordingly contain individual semantic information describing respective tokens in vocabulary 902. Embedding matrix 904 can be generated for vocabulary 902 using various methods of semantic analysis, such as by training a NN to generate the particular semantic information for each respective token in vocabulary 902. Although shown in FIG. 9 in reference to an input vector from FIG. 8, it is noted that a tensor such as the embedding vector 904 can be used as a general map or translation between embedding tensors and tokens, whether for input or for output, such as when an RNN generates an output embedding tensor as a result in NLP.

FIG. 10 illustrates a block diagram depiction of a computer system 1000, in accordance with one or more embodiments of this disclosure. Embodiments described herein may be implemented using a computer system, such as computer system 1000, in an individual manner or in a cluster of multiple computer systems. Accordingly, computer system 1000 may represent any of a variety of computing devices, such as, but not limited to personal computers, desktop computers, laptops, tablets, mobile devices, smart phones, cloud servers, blade computers, microcomputers, embedded devices, or modular computers, among others.

As shown in FIG. 10, computer system 1000 includes a processor subsystem 1020, a local system bus 1022 for interconnecting various local elements, a memory 1030, an operating system (OS) 1032, an input/output (I/O) subsystem 1040, a local storage resource 1050, a network interface 1060, and a network 1070.

As shown in FIG. 10, processor subsystem 1020 may include an integrated circuit (IC), such as in the form of a semiconductor device that is formed using at least one substrate, such as silicon. Processor subsystem 1020 may accordingly be used for interpreting and executing program instructions and processing data that is stored either locally or remotely or both. Processor subsystem 1020 may include a central processing unit (CPU) that uses an instruction set architecture to execute instructions, such as, but not limited to an advanced reduced instruction set computer (RISC) machine (ARM) architecture or an x86 architecture. A CPU included with processor subsystem 1020 may include one core, multiple cores, or multiple types of cores. The cores in the CPU can include optimized cores, such as performance cores, power-efficient cores, hybrid cores, or specialized cores that can be optimized for a particular function or performance attribute (e.g., low power consumption, a given data width/precision, level of complexity, etc.) Processor subsystem 1020 may include multiple ICs in a 3D configuration, including ICs on different substrates that may be combined using various 3D hybrid integration techniques in semiconductor processing. Processor subsystem 1020 may include a CPU for executing program instructions to optimize the use of multiple cores using parameters such as but not limited to performance, energy, load balancing, throughput, wait time, and response time.

In particular embodiments, processor subsystem 1020 may represent or include a single processor or multiple different kinds of processors, such as but not limited to a CPU, a graphics processing unit GPU, a neural processing unit (NPU), a tensor processing unit (TPU), a hardware accelerator, a field programmable gate array (FPGA), an application specific integrated circuit (ASIC), or general logic circuitry. For example, processor subsystem 1020 may include a system-on-chip (SoC) implementation that combines different kinds of processors onto a unitary substrate or package that can be customized for a given application or use case. In particular embodiments, the SoC included with processor subsystem 1020 can accordingly include different CPU cores, CPU cache memory, a GPU, display engines, I/O interfaces (similar to I/O subsystem 1040 described below), or an NPU, among other elements.

In some implementations, a general-purpose CPU can be used for various acceleration, for example when flexibility in the kinds of calculations is desired, or when logical operations with large numerical values are involved. A GPU can also be used for acceleration to process high data volumes using relatively simple compute units that can be configured to execute in parallel. In certain embodiments, a video decoder/encoder can be implemented in hardware, such as integrated in a SoC, for acceleration of video processing. In certain embodiments, a SoC can include an image signal processor (ISP) that can provide advanced camera support, such as when computer system 1000 includes an integrated camera device.

In particular embodiments, processor subsystem 1020 may support so-called “on-board AI” in which an AI/ML model can be executed in the hardware included with processor subsystem 1020 for acceleration of certain computational operations, such as linear algebra or matrix calculations. In particular, NPUs that operate similarly to GPUs may be used for on-board AI to achieve greater acceleration for execution of AI/ML models, and can achieve acceleration factors of 1,000× or 10,000× or greater with respect to other types of processors. For example, an NPU can be integrated with other elements in the SoC, as noted above. NPUs can be specifically implemented to execute mathematical operations related to NN processing, such as linear algebra and tensor operations (including vector and matrix operations). In this manner, NPUs can support large or very large AI/ML models that are NNs having 10\hat{ }9 or more neurons with multiple NN layers for complex logic. NPUs can be used, thus, for efficient execution of trained AI/ML models for on-board AI applications.

The linear algebra calculations performed by NPUs can include multiply-accumulate calculations, calculation of bias weights, or calculations of activation functions that may involve relatively simple and repetitive calculations performed at large scale, such as for on-board AI. As noted, in particular implementations, the linear algebra calculations performed by NPUs may be structured as matrix operations and can be executed using simplified compute units configured for parallel execution to improve acceleration. In particular NPU implementations, a large amount of memory can be included with or be accessible to the NPU, such as to support larger on-board AI applications. The memory used by the NPU can include random access memory (RAM) and cache memory that provides transient storage with high access speeds. Furthermore, to enhance acceleration, the NPU may be implemented to support lower precision numerical values, such as involving a smaller number of bits per numerical value, for NN calculations. In particular embodiments, the NPU can support integer values rather than floating point values for improved acceleration. As noted, the NPU may operate in a similar manner as a GPU. While the GPU may provide greater performance for executing AI/ML models, NPUs may be particularly suited for low-power consumption, such as in wireless devices or in smaller devices. NPUs may accordingly be well suited for use cases in which the AI/ML model executes continuously, such as for background tasks that the NPU can process independently without the CPU or the GPU, for example.

As shown in FIG. 10, a local system bus 1022 may represent a variety of suitable types of bus structures, such as but not limited to a memory bus, a data bus, an address bus, a control bus, or a peripheral bus, among various other examples.

As shown in FIG. 10, memory 1030 may include a system, device, or apparatus operable to retain and retrieve processor-executable instructions or data or both, such as for a period of time. Memory 1030 may include volatile memory such as RAM, including video RAM (VRAM), static RAM (SRAM), or dynamic RAM (DRAM), cache memory, and non-volatile memory. Memory 1030 may include or represent a computer-readable non-transitory medium that includes, but is not limited to portable or non-portable storage devices, optical storage devices, magnetic storage devices, or various other storage media. The processor-executable instructions may include a procedure, a function, a subprogram, a program, a routine, a subroutine, a module, a software package, a data object, a data structure, or a program statement, or various combinations thereof.

As shown in FIG. 10, an OS 1032 is stored in memory 1030. OS 1032 may represent an execution environment for various program code executing on computer system 1000. OS 1032 may be any of a variety of standard or customized operating systems, such as but not limited to a Microsoft Windows® operating systems, a UNIX or a UNIX-based operating system, a mobile device operating system, an Apple® MacOS or iOS operating system, an embedded operating system, or a hypervisor for executing multiple virtual machines on common hardware, among others. OS 1032 can be an operating system that supports shared memory, distributed memory, virtual memory, contiguous or non-contiguous memory allocation, among other memory arrangements. Also shown included with memory 1030 is an RNN 1034 that represents instructions executable by processor subsystem 1020 for implementation of the methods and system described herein for persistent fixed-size memory for ML. Although RNN 1034 is depicted in FIG. 10 as executable instructions (e.g., software code), RNN 1034 can be implemented in various embodiments, such as in hardware or a combination of hardware and software. For example, in some embodiments, at least certain portions of RNN 1034 can be implemented using a CPU, a GPU, an NPU, a TPU, a hardware accelerator, an FPGA, an ASIC, or using general logic circuitry, among other types of hardware or ICs, or various combinations thereof.

As shown in FIG. 10, in computer system 1000, I/O subsystem 1040 may include a system, device, or apparatus generally operable to receive/transmit data to or from or internally within computer system 1000. In different embodiments, I/O subsystem 1040 may be used to support various peripheral devices, such as but not limited to a touch panel, a display adapter, a keyboard, a touch pad, and a camera. I/O subsystem 1040 may represent a variety of communication interfaces such as, but not limited to, graphics interfaces, video interfaces, user input interfaces, and peripheral interfaces. I/O subsystem 1040 may support various output or display devices, such as but not limited to a screen, a monitor, a general display device, a liquid crystal display (LCD), a plasma display, a touchscreen, a projector, a printer, or an external storage device. In some instances, I/O subsystem 1040 can support multimodal systems that allow a user to provide multiple types of I/O to communicate with computer system 1000.

As shown in FIG. 10, local storage resource 1050 may comprise non-volatile or persistent computer-readable media such as a hard disk drive, CD-ROM, and other type of rotating storage media, flash memory, electrically erasable programmable read-only memory (EEPROM), or another type of storage media, and may be generally operable to store instructions and data and to permit access to stored instructions and data on demand. Local storage resource 1050 may include a storage appliance or a storage subsystem having one or more arrays of storage devices such as for supporting redundancy, mirroring, or real-time data error correction and restoration.

As shown in FIG. 10, network interface 1060 may facilitate connecting computer system 1000 to network 1070. Network 1070 may represent various configurations, such as but not limited to a local area network (LAN), a wide area network (WAN) such as the Internet, or a mobile network, such as a wireless network. Network interface 1060 may accordingly include or support wireless networks or wired networks. The wired network media supported by network interface 1060 (or included in I/O subsystem 1040) may include analog media, universal serial bus (USB), Apple® Lightning®, Ethernet, peripheral connect interface express (PCIe), DisplayPort (DP), Thunderbolt, fiber optics, a proprietary wired media, or an ad-hoc network media, among others. The wireless network media supported by network interface 1060 may include or support visible light communication (VLC), worldwide interoperability for microwave access (WiMAX), a Bluetooth® wireless signal transfer, an IBEACON® wireless signal transfer, an radio-frequency identification (RFID) wireless signal transfer, near-field communications (NFC) wireless signal transfer, dedicated short range communication (DSRC) wireless signal transfer, 802.11 WiFi wireless signal transfer, wireless local area network (WLAN) signal transfer, infrared (IR) communication wireless signal transfer, global navigation satellite system (GNSS), global system for mobile communication (GSM), such as 3G/4G/5G/LTE cellular data network wireless signal transfer, radio wave signal transfer, microwave signal transfer, infrared signal transfer, visible light signal transfer, ultraviolet light signal transfer, or more generally, various kinds of wireless signal transfer along using radiation in a wavelength range of the electromagnetic spectrum.

FIG. 11 illustrates a block diagram depiction of a high-performance computing (HPC) cluster 1100. Embodiments described herein may be implemented using an HPC cluster, such as HPC cluster 1100 shown including multiple computer systems 1000-1, 1000-2, 1000-3, 1000-4. Although four computer systems 1000-1, 1000-2, 1000-3, 1000-4 are shown in FIG. 11 for descriptive purposes, it is noted that any number of computer systems 1000 may be used. In particular embodiments, a large number of computer systems 1000 may be aggregated in HPC cluster 1100 to provide greater computing capacity. Accordingly, workloads, may be executed in a distributed manner in HPC cluster 1100, by implementing multi-node application execution, such that multiple computer systems 1000-1, 1000-2, 1000-3, 1000-4 share processing of work tasks that may be performed in a parallel or simultaneous manner.

As shown in FIG. 11, HPC cluster 1100 can be described in general terms as a collection of computer systems 1000-1, 1000-2, 1000-3, 1000-4 or any number of computer systems that respectively include a local processor and local memory and are interconnected by high-speed local network 1122, which may be a dedicated high-bandwidth, low-latency network. HPC cluster 1100 can accordingly aggregate and combine the computational power of multiple computer systems 1000-1, 1000-2, 1000-3, 1000-4, or any number of computer systems, to perform large-scale work tasks. HPC cluster 1100 can flexibly scale HPC resources that can be matched to desired work tasks. HPC cluster 1100 can also provide cluster configuration for work task parallelization, data distribution, parallel execution, cluster monitoring and control, as well as supporting parallelized computations having combined output. Various software applications can

As shown in FIG. 11, HPC cluster 1100 is shown including a storage system 1150, which may represent one or more storage devices that are compatible with high-speed local network 1122. High-speed local network 1122 may be a dedicated local bus such as including InfiniBand, 40 Gb Ethernet, or PCIe. Accordingly, storage node 1150 can provide access to storage resources using low latency high-speed local network 1122 to support HPC work tasks handled by HPC cluster 1100. It is further noted that HPC cluster 1100 may include a dedicated network interface that can provide network connectivity by using computer systems 1000-1, 1000-2, 1000-3, 1000-4, or another number of computer systems.

### Persistent Inference and Learning Properties

In particular aspects, computer systems and computer-implemented methods for persistent fixed-size memory for ML using RNNs are disclosed that can learn robustly and for long periods of time, including for substantially indefinite periods of time or indefinitely, from experience obtained from previous input information. Specifically, the methods and systems disclosed herein can provide certain advantageous features when carrying out inference on larger input sequences. For longer input sequences, inference characteristics can remain unchanged.

In some implementations, the inference computational effort and resources consumed can remain substantially constant over time. That is, the number of system cycles needed to carry out the activation functions of each timestep is not significantly lengthened by the number of previous timesteps carried out. Variation in the resources consumed for each individual timestep is not precluded, but the variation is not due to computation complexity introduced by the overhead of previous timesteps and concomitant processes (such as interleaved memory steps). As such, computational effort can remain linear over time.

In some implementations, the inference memory consumption can remain bounded or constant over time. That is, fixed-sized memory can be used, such that the network state of the RNN (encoded in multi-dimensional tensors as described above) can remain bounded in size over time during operation. Some processes may utilize transient or volatile memory portions outside of fixed memory that can remain bounded or constant over time, such that an overall size of the network state of the RNN remains bounded in the long-term. In other words, in each timestep, the memory consumption can remain substantially bounded or constant, thereby avoiding memory overflow issues that are not desirable.

In some implementations, the learning characteristics of the RNN can remain robust and stable over time. Later feedback, backpropagation, and memory processes have the same impact on the network state of the RNN as earlier processes without regard for a respective time order. Furthermore, the network state can continue to be modified in subsequent timesteps without introducing normalization or instability.

In some implementations, the RNN can retain information for an arbitrary number of time steps. For example, unused learned information and skills can remain unaltered unless modified by a memory step for updating. The update processes may avoid the decay of parameters and information learned in prior network states.

In some implementations of the RNN, the size of the memory state is sufficient to accommodate the full parameterization associated with a modern LLM. For example, the memory state may comprise a context representation in excess of 10\hat{ }9 parameters. As another example, the context representation may exceed 10\hat{ }12 parameters.

In particular embodiments, the following additional features to the baseline features can be provided for enhanced or more desirable operation:
Independence from embedding methods that encode a position within the sequence.
Inclusion or consideration of a substantial portion or a majority of model parameters within the network state of the RNN.
Capability of accelerating model inference beyond one input token per timestep. For example, inclusion of a batching mechanism that can process multiple simultaneous inputs within a single timestep.
Capability of combining learned information using parallel inference passes.
A method to determine where information has been sourced from, and whether to retain such information as fact.
A method to learn new information by reading the new information, rather than only learning the new information through gradient descent training on a generation task, which may be a property of the capabilities of the methods and systems described herein.

### Constant Inference Speed Per Token

The feature of constant inference speed per token can be implemented as a sequence model with a very long time period, such as an indefinitely long time period. Typical transformers may exhibit a constraint on an ability to process input sequences having an arbitrarily long length, in part because of an O(n\hat{ }2) computational effort involved, where every new generation attends to every preceding timestep. Typical approximations of the attention mechanism in such typical transformers may attempt to overcome this constraint but may either discard information or may not be able to operate over an indefinite time period, which are undesirable features.

The methods and systems disclosed herein may provide an inference computation effort per timestep that efficiently operates even after trillions of time steps, which is about six orders of magnitude greater than typical transformer architectures. Accordingly, the methods and systems disclosed herein may rely upon inference with constant computational effort per timestep that is a property of recurrent ML models.

### Constant Memory

Typical transformer architectures may retain a record of encodings of each timestep across an input sequence so that any arbitrary token in the input sequence can be referenced and processed at each timestep, resulting in inference memory consumption that is linear over time. Accordingly, as input sequences of experiences increase in size, the memory consumption to process a single timestep also increases, resulting in an inability to learn over a very long or an infinite time period due to physical memory constraints.

The methods and systems disclosed herein may have a capability of processing a sequence without increasing the memory consumption to process additional time steps, which is another property of recurrent ML models.

### Memory Logic Consistent and Stable Over Time

In typical AI/ML systems, when a linear operation is followed by a normalization operation, or when an operation is normalized over time, the effect of any new information may be reduced and may eventually converge to such a small effect, such that no further effect on future outputs may occur, effectively resulting in inoperability. Various other dependencies on input sequence length may have similar disadvantageous effects on memory operation when the preceding input sequence approaches a very long or an indefinite time period. Some implementations of the systems and methods described herein can learn over a very long or an indefinite time period, including an ability to rapidly and robustly integrate new information into memory independent of the length of the preceding input sequence. Another aspect of the methods and systems described herein is a stability of memory logic over longer time sequences, such as by being independent of the sequence length. A parameter that relies on the sequence length may be a potential source of instability. For example, a typical linear transformer such as the so-called “norm-former” can compute the kernel at time t as a sum of kernels leading up to t, which then normalizes the output of the linear operation. Without eventually normalizing the sum of kernels by the sequence length, the kernel in the norm-former could eventually include a magnitude that is difficult or impossible to compute by the computer system or processor performing the calculation. Similarly, a network state that is progressively written to without using information stored within the network state to compute a new network state may be vulnerable to magnitude instability in the network state update and reading mechanism.

### Retain Information Across an Arbitrary Number of Timesteps

The methods and systems disclosed herein may provide a useful ML model that is able to learn information and skills, build on them, and retain this information for a long period of time or indefinitely, and integrate the new information and skills into a global model. Accordingly, the methods and systems disclosed herein may provide memory mechanics that intelligently control when and whether information is removed/overwritten to prevent information loss. A typical memory mechanism that decays information in the memory buffer may store relatively short-term dependencies, and thus, may not support a long term or indefinite memory mechanism for this reason. Additionally, summed kernel approaches such as linear transformers with normalized outputs may be vulnerable to squashing the effect of earlier learning, such that over the long-term any observed impact on the memory state is minimal or absent.

However, stored information can also become out of date. A feature of memory mechanics of the methods and systems disclosed herein may include an ability to overwrite information as the information is replaced with more up to date representations or alter the information as new related information is stored. The methods and systems disclosed herein may control the dynamics of the memory mechanics, instead of exhibiting a lack of reinforcement over time. In one example, a math ML model may learn a robust understanding of mathematics up to linear algebra. The math ML model may then perform a few million timesteps on learning creative writing, with little overlap to mathematical understanding. The math ML model implemented according to the methods and systems described herein may retain the mathematical ability previously learned in this case because the neurons trained for the mathematical ability may remain unchanged without subsequent updates from the creative writing learning. As a result, the math ML model implemented according to the methods and systems described herein can learn creative writing without forgetting the mathematical ability learned.

### Very Large Recurrent Memory Size

As ML models increase in parameter and dataset size, the ML models may exhibit profound changes in memory, reasoning, and learning capabilities as well as other emergent properties. At a certain size the ML models may start to produce coherent outputs, and at another size the ML models may be able to intelligently discuss information from their training dataset as well as manipulate information within the preceding sequence. The methods and systems disclosed herein may have an ability to introduce or reintroduce the ML model's training set as well as additional information within the preceding sequence, such that the ML model is capable of cumulatively memorizing or compressing the introduced information, for example without substantial loss of information. Heuristically stated, the network state of the RNN (or equivalent representation) in the methods and systems disclosed herein can support at least as many parameters as a typical transformer model with similar capabilities.

ML models implemented according to the methods and systems disclosed herein may be capable of such emergent properties starting at a parameter count of about 3×10\hat{ }9 parameters, such that the network state of the RNN can include at least 3×10\hat{ }9 parameters using suitable computer systems and may include up to 10\hat{ }11 or more parameters.

### Elimination of Fixed Temporal Dependencies

Positional embeddings and other similar mechanisms such as rotary positional embeddings (RoPE) have allowed transformers to operate over sequences using a temporal component. Such mechanisms may create a fixed temporal dependency that puts a restriction on an effective sequence length. It has been shown that position embeddings that were not represented within a pre-training phase of an ML model lifecycle have adversely affected the performance of the ML model, and the adverse effect can be significant. While the adverse effect can be mitigated by finetuning the ML model on new embeddings and using interpolation to increase the effective size of the ML model's embedding memory state, such measures can place an upper bound on the sequence length that the ML model can process, which is undesirable.

In the methods and systems disclosed herein, where the ML model can learn over a long period of time or indefinitely, fixed temporal dependencies such as position encoding may be eliminated or replaced with a recurrent process or another process that can perform at least some of the same functions while remaining independent on a length of the input sequence. In some implementations, the position embeddings can be retained, such as to represent non-temporal information, such as an individual token's position when multiple tokens are processed within a single timestep.

### Most Parameters can be Part of the Network State

A typical transformer-style NN that lacks recurrent functionality encodes and retains a large number of explicit facts within the parameters of the ML model. The explicit facts retained can be accessed through the ML model's sequence processing logic. Training such a typical ML model can involve constructing autoregressive generation tasks, which can compel the ML model to memorize the large number of explicit facts for accurate completion.

The methods and systems disclosed herein can provide an ML model having the network state of the RNN that is capable of dynamically storing, modifying, and updating factual information as new data is acquired. For this purpose, the ML model according to the methods and systems disclosed herein may use a memory state that is recurrent or dynamic. By storing a significant portion of the ML model's parameters within the memory state, the ML model may gain dynamic capacity for effectively managing new information and old information. As a result, the ML model according to the methods and systems disclosed herein can exhibit an enhanced ability to achieve desired memory characteristics and performance, while providing robust,

flexible information management that permits learning information through consumption of media, for example.

### Capable of Accelerating Recurrent Operations

Conventional ML model algorithms that are formulated in recurrent form may be unable to parallelize computations for simultaneous execution.

The methods and systems disclosed herein introduce a formulation that can process multiple inputs simultaneously, which can enable acceleration of processing multiple inputs that occur simultaneously, as well as enable acceleration of batches of sequential information. Furthermore, methods are described for merging at least certain portions of network states produced from parallel inference over multiple sequences.

### Capable of Identifying a Source of Known Information

In certain typical pre-trained LLMs, the core architecture may be unable to identify a source of known information. For example, typical transformers may exhibit a problem where the ML model may generate ostensibly correct information without being able to identify a source of the information, such that the information in not actually correct. In other cases, the ML model may “hallucinate,” generating a plausible sounding but false answer with no identifiable source. Thus, typical transformers may be constrained to providing accurate information when the information being referred to is present in a preceding context of the input sequence, so that the source of the information can be identified.

The methods and systems disclosed herein may be capable of identifying when an ML model does or does not know something, while being capable of identifying a source of an arbitrary piece of information that the ML model generates.

### Capable of Evaluating Quality of New Information

In some typical pre-trained transformer LLMs, one disadvantageous feature may result from being trained on a wide variety of information from a wide variety of sources, such that all training information is memorized in an attempt at best fitting the training information. Such typical LLMs may rely on behavioral finetuning as a safety mechanism to keep the ML model from generating information based on untrusted sources or producing inflammatory information.

The methods and systems disclosed herein may provide a training behavior that can enable an ML model to be instructed about the nature of acceptable public discourse. Additionally, the training behavior can enable the ML model to identify trustworthy sources of information, as well as identify why certain sources of information are trustworthy, before the ML models are trained on a wide array of information from a variety of different sources of different quality.

In particular aspects of the disclosure, further details of timestep execution of RNN implementations, including aspects related to memory storage and memory performance, are presented. A recurrent sequence model that is capable of learning for long periods of operation, such as approaching continuous operation, may operate without intermittently performing backpropagation using gradient descent. As will be described in further detail, a core memory mechanism is disclosed that can facilitate sparse reading from and sparse writing to a distributed memory buffer, referred to as a memory state W that occupies a “state space” having a certain size. The core memory mechanism may perform multiple reads and multiple writes in parallel execution within a single timestep.

Additionally, computation of sparse vectors within a state space that is large or very large is disclosed. In the place of operations that are costly and inefficient for very large numbers of inputs and projection parameters regardless of density, linear transformers are used that capitalize on the low density of data within the large space.

Within this disclosure, “sparsity” is a fractional value that describes the proportion of the data structure for which the stored data is null (e.g., uninitialized, zero, etc.). For instance, a memory state in which 90% of the values were null would have a sparsity of 90%. Unless otherwise specified, a memory state or data structure is considered “sparse” if its sparsity is 75% or greater. This disclosure includes the use of processes for which efficiency depends on sparsity and the use of projections onto higher-dimensional state spaces in order to increase sparsity.

Aspects of the disclosure also estimate effective memory capacity for an RNN layer implementing the core memory mechanism. The operation of the core memory mechanism may be comparable to the operation and memory capacity of conventional transformer models. Furthermore, methods for merging memory states from multiple instances of model inference are disclosed that can facilitate parallelization of inference training passes. The core memory mechanism can be incorporated into a sequence model with a training approach that allows the

sequence model to learn a set of initial experiences and retain experiences that can enhance the sequence model's performance on certain downstream tasks. Certain learning paradigms enabled by large-scale inference time learning are disclosed, along with different applications that may leverage experience-based learning and behavior optimization, without relying on gradient descent-based training.

### Transformer Operation

Certain typical generative AI/ML models, such as LLMs, ViTs, or so-called Large Multimodal Models (LMMs), may utilize a transformer architecture that includes a model backbone, such as ML model 700, that can operate together with augmented functionality in the form of residual blocks. The residual blocks may accumulate values over timesteps that are computed by a self-attention operation or a feedforward operation. In general terms, a residual block can include an operation that computes a sum update to the original representation.

### Alternative Focus Mechanism

The present disclosure introduces an alternative focus mechanism to the softmax attention mechanism explained below. While self-attention is typically defined to include a softmax non-linear normalization function, a focus mechanism is described that approximates self-attention without the use of this function.

In a typical generative AI/ML model, a self-attention mechanism may be implemented as at least one residual block and may include a softmax self-attention function. The softmax self-attention mechanism can enable a typical generative AI/ML model to weigh the relative importance of different tokens in an input sequence. The softmax weighting mechanism can be used for representing at least some of the previous tokens within the input sequence. For example, given an input sequence X (e.g., input sequence data), the softmax self-attention mechanism can compute a weighted sum of values V using queries Q and keys K. In [eq:3], [eq:4], and [eq:5] respective formulas for Q, K, and V are given.

$$Q = {W}_{q} X$$

$$K = {W}_{k} X$$

$$V = {W}_{v} X$$

In [eq:3], [eq:4], [eq:5], W_{q}, Wₖ, and Wᵥ are respective learned projection matrices (or simply “projections”) that contain information trained in a generative AI/ML model. The matrices W_{q}, Wₖ, and Wᵥ may be similarly sized as embedding matrix 904 shown in FIG. 9. The output of the softmax self-attention mechanism can be given by an attention score Y, as given in [eq:6].

$$Y = softmax ( \frac{Q \cdot {K}^{T}}{\sqrt{{h}_{k}}} ) \cdot V$$

In [eq:6], hₖ is the length of the key vector K, which is equal to h_{q}, the length of query vector Q. In particular implementations, embedding vector xₜ 802 is used for query vector Q such that hₖ and h_{q} are equal to h from FIG. 8. For generative AI/ML models that are autoregressive, [eq:6] may effectively apply a mask during training time to prevent consideration of tokens that are subsequent to the present token (corresponding to the present timestep) being processed by the AI/ML model when [eq:6] is evaluated.

The softmax self-attention mechanism may be absent of information indicative of a location of previous tokens within a sequence. For example, a first key/value pair located at or near an initial timestep may have the same impact on the softmax self-attention mechanism as a second key/value pair located at or near a final timestep, such as for calculating another projection for a subsequent timestep. To overcome this potential constraint, which may be relevant in Encoder Only transformer architectures that may be implemented without a temporal mask, transformer architectures may typically apply a positional encoding mechanism to the projections within a given sequence. Various strategies for applying the positional encoding mechanism can include positional embeddings (static embeddings unique to each position in the sequence) or rotary embeddings (relative positional encodings added to the key and query vectors for continuation rotation of embeddings).

Experimental evidence has shown that using positional encodings that are absent in the training phase can lead to a decrease in performance of the transformer architecture. In some instances, the decrease in performance may be significant.

The softmax attention mechanism may include an attention residual block that can first perform a normalization operation and then compute updated projections in addition to evaluating

[eq:6]. The attention residual block may then compute another linear projection before adding a final result to the input vector of the attention residual block.

In particular implementations, a multi-headed attention residual block can be implemented in which each individual head processes a different portion of the input vector to compute a sub-projection for each head. Then, the individual sub-projections can be concatenated before generating a cumulative projection as the output vector. Table 1 below contains pseudo code for evaluating [eq:6] in the case of a multi-head attention arrangement that forms the attention residual block in aggregate.

TABLE 1
Pseudocode for an attention residual block.

```
def attention_block(X, W_Q, W_K, W_V, W_O, d_k) :
  X_norm = layer_norm(X)
  X_norm = split_heads(X)
  heads = [ ]
  for i in range(X.shape[−2]):
    Q = dot(X_norm[..., i, :], W_Q[i])
    K = dot(X_norm[..., i, :], W_K[i])
    V = dot(X_norm[..., i, :], W_V[i])
    head = self_attention(Q, K, V, d_k)
    heads.append(head)
  multi_headed_output = concatenate(heads, −1)
  return X + dot(multi_headed_output, W_O)
```

In the transformer architecture, a feedforward residual block may receive the output from each attention residual block. As a result, the transformer architecture may include alternating attention residual blocks and feedforward residual blocks. In particular embodiments, the feedforward residual block may include a significant portion or most of the parameters within the transformer architecture. The feedforward residual block can perform a normalization operation, then generate a first linear projection and a second linear projection with a non-linear activation operation therebetween. One such non-linear activation operation may be a ReLU function, such as a simple ReLU (defined as ReLU(x)=max(x, 0), rectifying any negative value to zero). In the feedforward residual block, the second linear projection can then be added to the input vector to produce the resulting output vector, as given by [eq:7].

$$y = x + ReLU ( layernorm ( x ) \cdot {W}_{1} + {b}_{1} ) \cdot {W}_{2} + {b}_{2}$$

Some architectures may use other linear units in their activation operation, such as exponential (ELU), sigmoid (SiLU), a leaky rectifier function, or the like.

A focus mechanism is described herein which eliminates the need for the softmax function or any similar non-linear normalization function, which can add unnecessary dependency and inefficiency when applied to large input sequence data. Instead, a linear transformer is applied.

The term “linear transformer” may refer to a linearly increasing computational effort for the focus mechanism associated with the input sequence, rather than a constraint of linearity for a given operation being performed. The linear transformer can provide a similar projection operation on the query, key, and value vectors.

Specifically, when the softmax function is removed from [eq:6], the result is given by [eq:8]:

$$Y = ( Q \cdot {K}^{T} ) \cdot V = Q \cdot ( {K}^{T} \cdot V )$$

It has been shown that projecting Q and K randomly (or by preserving orthogonality) onto a much larger state space can approximate the softmax function as follows:

$${y}_{t} = ϕ ( {q}_{t} ) \cdot {{\sum }_{i = 0}}^{t} ϕ ( {k}_{i} ) ⊗ {v}_{i}$$

Capitalizing on the sparsity of the state space to minimize the mean complexity of the matrix multiplication, [eq:9] can provide a desirable rectification of values at a greater efficiency than the use of softmax. [eq:9] can also be restated in terms of a recurrent network using [eq:10] and [eq:11].

$$Δ {W}_{t} = {v}_{t} ⊗ ϕ ( {k}_{t} )$$

$${y}_{t} = ( {W}_{t - 1} + Δ {W}_{t} ) \cdot ϕ ( {q}_{t} ) = {W}_{t} \cdot ϕ ( {q}_{t} )$$

The recurrent network described in [eq:10] and [eq:11] has long-term stability: that is, when there is low variance between timestamps in the values of k, the differences in the weights ΔW will be small so that the weights W converge.

One modification to the linear transformer, referred to as Delta Net, utilizes an update step in place of constructing an entirely new kernel at each timestamp. The update step computes a direction in which information in memory state W could be read from and written to. A Delta Net update rule is given by [eq:12], [eq:13], and [eq:14].

$${\overline{v}}_{t} = {W}_{t - 1} ϕ ( {k}_{t} )$$

$$Δ {W}_{t} = ( {v}_{t} - {\overline{v}}_{t} ) \cdot σ ( β ) ⊗ ϕ ( {k}_{t} )$$

$${y}_{t} = ( {W}_{t - 1} + Δ {W}_{t} ) \cdot ϕ ( {q}_{t} ) = {W}_{t} \cdot ϕ ( {q}_{t} )$$

As noted with respect to the linear transformer above, the advantage of Delta Net over a naïve kernel matrix update can be significant when applied to a memory state W representing a large number of memory states for which most memory states represent null or empty data (that is, a sparse data set).

### Sparsity and Parameter-Free Projection

A large capacity linear transformer is reliant on the existence of a large state space for key and query vectors; sparse if the space is all-positive. In some implementations, the linear transformer can be modified to artificially establish these conditions, such as through the use of a Deterministic Parameter-Free Projection (DPFP) operation. DPFP operates to project a vector onto a larger state space under the constraints that orthogonality is preserved (any two vectors that are orthogonal to each other have orthogonal projections) and that the resulting projection is more sparse than the untransformed set.

As the DPFP projection grows into a larger state space, the performance of Delta Net approaches the performance of a softmax attention transformer trained to perform the same task. For example, as experimentally determined, a DPFP with a fixed sparsity of 75% will have far less complex dependency than softmax while producing a similar transformation. A normalization technique that may be used for DFDP is given by [eq:15].

$${ϕ}^{′} ( k ) = \frac{ϕ ( k )}{\sum ϕ ( k )}$$

In certain embodiments, the methods and systems disclosed herein provide an RNN model and architecture that makes information available across time by sparsely writing to and reading from a network state that can be very large.

### Memory Mechanism

The methods and systems disclosed herein include a memory mechanism that operates by reading information from a memory matrix using a dot product with a query vector, and by writing to the memory matrix by constructing an update to the memory matrix such that a value written can be read from the memory matrix exactly if read (e.g., queried) immediately after the update (e.g., write operation).

### Memory

As disclosed herein, a memory matrix can serve as a buffer that can be read from and written to. The read and write operations to and from the memory matrix are designed to be differentiable in order to propagate gradients through the read/write operation as well as through time, while updates can be designed to be composable so that a network state of the ML model can be reconstructed during backpropagation, which is desirable, instead of keeping a copy of the network state for every time step, such as in conventional ML models, which is undesirable.

### Read Mechanism

For a given memory state of a memory matrix W and query vector x, a value y stored in W at x can be found using a simple matrix multiplication as given by [eq:16]. It is noted that x may represent an input sequence that is used as a query vector, also referred to as q.

$$y = Wx$$

### Write Mechanism

Writing a value vector v to a location given by a key vector k in the memory matrix W updates the memory matrix W with an update matrix ΔW such that the result of reading k from W is equal to v, as given by [eq:17].

$$v = ( W + Δ W ) k$$

Further, the update matrix ΔW can be found using the algebraic derivation given in [eq:18], [eq:19], [eq:20], and [eq:21].

$$v = Wk + Δ Wk$$

$$Δ Wk = v - Wk$$

[eq:20] and [eq:21] describe a Moore Penrose Inverse.

$$Δ Wk \cdot \frac{{k}^{T}}{{k}^{T} k} = \frac{( v - Wk ) \cdot {k}^{T}}{{k}^{T} k}$$

$$Δ W = \frac{( v - W k ) ⊗ k}{\sum {k}^{2}}$$

### Adding Gating Mechanism

The update mechanism given in may limit a maximum number of orthogonal locations that store values to a size of vector k, which is undesirable. Additionally, the processing of identical values in a sequence may be hampered when the same value is present multiple times in a row in the sequence. When the update mechanism of [eq:17] attempts to use the information from the identical value by storing v in W at k, the value v is already stored in W at k, such that the update mechanism would result in storing values that are semantically identical, and thus, adds no new information to the context in the same location.

It may be desirable to have a mechanism to allow the memory to store a value with an opacity, such that one update does not necessarily immediately write the entire value to the memory. A known gating mechanism is given in [eq:22].

$$Δ W = \frac{( v - W k ) ∘ σ ( β ) ⊗ k}{\sum {k}^{2}}$$

In [eq:22], p is a logit weight vector the same size of v produced along with v and, and σ( ) is the sigmoid operation to assure that gating values are between 0 and 1. Applying the sigmoid operations yields a gate vector σ(s) that acts as an opacity of the writes over the output, with values between 0 and 1 allowing writing of partial information that can be used to write different values when the same value is used repeatedly in a sequence.

### Large Sparse Key State Space

In various embodiments, a state space dimensionality can be a limiting factor on the expressivity and fidelity of a memory matrix. Therefore, methods and systems disclosed herein may maximize the state space used to represent the key and query mechanism of the disclosed memory architecture. In order to maximize the computation characteristics and take advantage of the mechanics of sparsity, the disclosed memory architecture uses a projection onto a larger state space with a controllable sparsity mechanism.

### Batch Memory Mechanism

As disclosed herein, a series of boundary conditions that may be satisfied in order to process multiple input values in batch. Also disclosed is a derivation of an operation as well as approximations that can be used to compute batch updates to a ML model's memory matrix.

### Replacement or Removal of Position Embeddings

As disclosed herein, empirical evidence is presented that a similar memory mechanism may avoid using positional encodings in order to effectively process sequential information. Further disclosed is a recurrent process that can learn to encode some of the recent history of the ML model's sequential processing.

### Feedback Mechanism

A design and training procedure is disclosed for applying a feedback mechanism to the functionality of an ML model utilizing the recurrent process, in order to compress learning into lower layers of the network.

### Pre-Training

A design of a pre-training process is disclosed that utilizes gradient descent to allow the ML model to memorize and learn at inference time.

### Inference Based Learning

An approach to inference-based learning is disclosed that can allow a ML model to learn from experience for a very long period of time or an indefinite period of time.

### Sparse Memory

Certain optimal properties of x may exist in the context of reading and writing vectors to W at x.

### Representations Constrained to Positive Values

In vector representation space, the negative, negation, or opposite of a piece of information in a vector may be different from a simple representation of a negative vector of the vector. Such negations can be unique information and may be represented at distinct, orthogonal locations. Under the assumption that recalling information stored at the negative of the location the information was stored is not desirable, a property that key/query vectors should only contain values greater than or equal to zero may be enforced.

### Key Vectors Limited to Storing Direction

One property of the update mechanism given in [eq:19] that lacks stability can be that the update mechanism has an inverse relationship with the magnitude of values stored in k, also referred to as the scale of k. As the scale of vector k gets larger, the scale of the computed update ΔW gets smaller, because the value written at k is retrievable by a vector with the same scale as k. As the scale of k gets larger and larger, the scale of resulting data written at k/\sqrt{Σk²} approaches zero. Conversely, as the scale of k gets smaller approaching zero, the resulting data written at k/\sqrt{Σk²} gets larger in scale approaching infinity. If a read requests a value using a query vector with a large scale at the same location where a vector was written using a key vector having a small scale, there is a possibility of a runtime overflow error. Additionally, at write time, scale may already be controlled by v and σ(β).

As a result, for writes, it can be optimal to obtain a vector k that has a scale of 1, or at least a constant scale (a constant that is not equal to 1 may be used with quantization techniques). Such scaling can be used to generate k′ using a scale vector a as given by [eq:23].

$${k}^{′} = α \frac{k}{\sqrt{\sum {k}^{2}}}$$

For read operations there may be no mechanism to modify the scale of retrieval except with the scale of the query vector x (or more generally q). In order to allow for scale in queries during the read mechanism, either the query vector q is not normalized by its length, or scale vector α is used for the result y, as given by [e:24] or [eq:25] respectively.

$$y = Wq$$

$$y = α W \frac{q}{\sqrt{\sum {q}^{2}}}$$

### Controllably Sparse Key and Query Vectors

Sparsity can introduce several properties to the read/write system described above, including:
Isolating write operations such that writing v₂ to W at k₂ may leave Wk₁ unchanged.
Allowing for some information overlap so if k2 partially overlaps k1 the existing memory matrix is updated at k1 with new, more salient information.

### Key and Query Having a Large Space

The larger the vector length of the key vectors and the query vectors, the larger the state space of the memory system. Also, a maximum number of orthogonal vectors for the key vectors and the query vectors increases linearly with the length of the key vectors and the query vectors.

### Vector Spaces Without Duplicate Values

DPFP is a known projection method that aids in efficient sampling. In DPFP, a vector of one size is projected onto a vector of a larger size while preserving orthogonality and preventing individual elements from the original vector from being oversampled within local windows.

DPFP computes a vector cross product with the same input vector along a diagonal, resulting in an output vector having a length extending to the square of the length of the input vector (along with some other operations discussed later). One drawback of DPFP can be that nearly half of the values in the output vector are duplicates (e.g., x1×2 is a duplicate of x2×1). As a result, essentially half of all computation may be redundant when top_k( ) is used to select indices for sparse values. Accordingly, the methods and systems disclosed can generate the first n/2−1 diagonal rows in order to avoid duplicates, reduce or eliminate redundant computational effort, and thereby improve computational tractability.

### Projection Techniques for Large State Spaces

The methods and systems disclosed herein may apply to at least one of the following operations to obtain a vector in a large state space.

A vector-vector cross product operation computes all or part of the matrix that represents the cross product between two vectors. Various projection techniques can produce a large vector and/or sparse vector based on two vectors or a vector and itself. A diagonal product operation is a technique by which the cross product is computed or sampled from diagonally, sometimes with an offset to avoid computing the diagonal of the cross-product matrix first. The methods and systems disclosed herein can apply the following techniques that utilize vector-vector cross products:
Concatenate vector max(x, 0) with max(−x, 0) and the vector softmax(concatenate(x, −x)) 2 dₓ where dₓ is the number of components in vector x, where the vector-vector cross product is computed diagonally.

$$DiagonalProduct ( max ( conca t ( x , - x ) , 0 ) , softmax ( concat ( x , - x ) ) * {d}_{x} )$$

Compute the diagonal product of max(x, 0) with max(x, 0) normalized by the sum of max(x, 0)*dₓ, as given by [eq:26B]:

$$\frac{DiagonalProduct ( max ( x , 0 ) , max ( x , 0 ) )}{\sum max ( x , 0 ) * {d}_{x}}$$

A large vector can also be obtained by a linear process, examples being a linear projection or a chain of linear projections.

TABLE 2
Algorithm for producing a large sparse vector

```
def projection(x, num_samples, sparsity, normalize_y=True):
  x_relu = concatenate(max(x, 0), max(−x, 0))
  # 2 * x_size (doubling dimensionality via concatenate(x, −x))
  x_softmax = softmax(concatenate(x, −x))
  x_proj = diagonal_product(x_relu, x_softmax, num_samples)
  y_values, y_indices = sparsify(x_proj, sparsity)
  if normalize_y:
    y_values = y_values / sqrt(sum(power(y_values, 2)))
  return y_values, y_indices
```

The algorithm in Table 2 for producing a large sparse vector may perform a diagonal product expansion and a sparsification operation, followed by an optional normalization operation such as division by the vector length. The sparsification operation and diagonal product operation may be performed as a single operation in order to avoid needing to store the entire result of the cross-product sampling. For GPU execution, local methods may be selected to prevent computing a reduction operation, while top_k( ) may be used in particular embodiments.

If the diagonal product is obtained using the DPFP algorithm, the derivative of this operation is on the order of x\hat{ }2. This has typically been addressed by dividing by the sum of the resulting vector. However, the methods and systems disclosed herein provide two different postprocessing techniques:
Normalizing the resulting vector by dividing the resulting vector by its size.
Normalizing the resulting vector by dividing the resulting vector by a sum of the concatenated ReLU of the original vector, as given by [e:27]:

$$\frac{dpfp ( x )}{\sum max ( conca t ( x , - x ) , 0 )} = \frac{dpfp ( x )}{\sum abs ( x )}$$

The methods and systems disclosed herein may apply at least one of the following projection techniques:
DPFP
Basic algorithm 1: Concatenate max(x, 0) with max(−x, 0).
Basic algorithm 2: Iteratively compute a cross product of a vector with itself along the diagonal, such as given by:

```
(x1x2, x2x3, x3x4 ... xn-1xn, xnx1, x1x3 ... xn-2xn, xn-1x1, xnx2, x1x4 ... )
  Eventually can lead to duplicates in the output vector by computing the entire product
  matrix, therefore, compute the first (n/2 − 1) diagonal vectors to avoid duplicates and
  redundant calculations.
  $Maximum vector space from vector of length n is ( \frac{{n}^{2}}{2} - n ) .$
  Negatives of a vector are orthogonal to each other.
  Preserve orthogonality from the original vector, as given by [eq: 28]:
        σ(x) = DiagonalProduct(cat(max(x, 0), max(−x, 0)), 1, 2 * dₓ)
  Large matrix multiplication, as given by [eq: 29]:
φ(x) = Wx
  Butterfly matrix multiplication, as given by [eq: 30]:
φ(x)=W₂(W₁x)
In [eq: 30], W₁ projects x onto a smaller state space and W₂ projects the representation
W₁(x) onto a very large state space.
  Lower triangle product, similar to DPFP but computes the lower triangle of the product
  with itself, as given by [eq: 31]:
    φ(x) = LowerTriangleDiagonalProduct (cat(max(x, 0), max(−x, 0)))
  [eq: 31] may capture a row of zeros along the offset of the length of x.
  Diagonal Product with ReLU, similarly motivated to DPFP, avoids the concatenation of
  ReLU(x) with ReLU(−x), instead uses ReLU activation function over x and performs a
  diagonal product of the resulting vector, selecting up to n/2 rows and normalizing by
  the sum of the activated vector, as given by [eq: 32]:
$ϕ ( x ) = \frac{DiagonalProduct ( max ( x , 0 ) , 0 , \frac{{d}_{x}}{2} )}{\sum max ( x , 0 )}$
  Diagonal Product between ReLU and Softmax, for normalization of the output to
  match the scale of x, a diagonal product can be constructed between ReLU(x) and
  softmax(x).
```

### Sparsification Techniques

The methods and systems disclosed herein may apply at least one of the following sparsification techniques:
top_k( )
Computes the indices and values of the largest k values in a sequence.
Can be difficult to compute in parallel, computed in O(n*log(k)) time.
local_max( )
Computes a maximum value within a local window of values and returns the index in the larger sequence along with the value itself.
Window can be simply splitting up sequence into bins to prevent overlap.
Highly parallelizable, computed in O(n) time.
local_top_k( )
Similar to local_max( ) but instead, computes k values for each window.
Parallelizable to a degree, still computed in O(n*log(k)) time, but k can be much smaller.
weighted_random_sample_without_replacement( )
Randomly sample k values and their indices from the activations in the vector, avoiding duplicate sampling of the same value twice and using the scale of the activations to produce a weight.
Can be difficult but possible to parallelize.
local_random_sampling( )
local_weighted_random_sampling_without_replacement( ) includes further parameters to refine local random sampling: namely, the same data is excluded from being randomly selected more than once, and known weighting is applied to selection of the sample.
Randomly sample k values within each window of vector.
Can be useful for adding regularization to the vector distributions.

### Sparse Vector Algorithm

The methods and systems disclosed herein may apply at least some of the exemplary sparse vector algorithm in Table 3.

TABLE 3
Exemplary Sparse Vector Algorithm

```
def projection(x, nu, sparsity, normalize_y=True, normalize_x_proj=True) :
  assert nu <= x.shape[−1] − 1
  x_relu = concatenate(max(x, 0), max(−x, 0))
  x_proj = diagonal_product(x_relu, nu)
  if normalize_x_proj:
    x_proj = x_proj / sum(x_relu)
  y_values, Y_indices = sparsify(x_proj, sparsity)
  if normalize_y:
    values = y_values / sqrt (sum (power (y_values, 2) ))
  return y_values, y_indices
```

The algorithm in Table 3 for producing a large sparse vector may perform the DPFP algorithm, cap the largest expansion for the operation to ensure there are no duplicate combinations or long stretches of zeros, optionally normalize the DPFP product with the sum of xᵣelu, and execute one of the sparsification methods outlined in the above section. For GPU execution, local methods may be selected to prevent computing a reduction, while top_k( ) may be used in particular embodiments. In some embodiments, the resulting vector may be normalized by the length of the resulting vector.

Normalizing both during the x_proj and y phase may be ineffective versus normalizing during the y phase by itself. However, scenarios where y normalization is omitted can become good candidates for x_proj normalization, which can overcome activations from the diagonal projection having a derivative similar to x\hat{ }2, while the sum normalization may flatten the derivative to be on the order of x. Normalizing during the x_proj phase may also allow for a richer gradient representation where the selected activations are competing against the non-selected activations. Normalizing during the x_proj phase may can be computed as given by [eq:33]:

$${ϕ}^{′} ( x ) = \frac{Φ ( x )}{\sum \vert x \vert}$$

In [eq:33], φ is the standard DFDP operation. Alternatively, x_proj can be calculated by normalizing one of the input vectors to the diagonal product by the some of the vectors.

### Encoder/Decoder Mode

In various implementations, sequence models can be broken down into three types of models: encoder-only models, decoder-only models, and encoder/decoder models. Encoder-only models can operate over an entire sequence simultaneously and produce a rich representation of the original sequence. Because encoder-only models use reversible functions, these models can be tasked with recreating the original sequence.

Decoder-only models are characterized by their ability to carry out autoregressive training algorithms, in which element prediction occurs in each memory step between timesteps. Decoder-only models allow for recurrent mechanisms as described above with respect to RNN systems.

Encoder/decoder models, while more costly than encoder- or decoder-only models, have the advantage of using the rich representations when carrying out the autoregressive training. In this way, the training capability of encoder/decoder models may have better predictive power and more fidelity to the original input sequence than decoder-only models.

### Mixture of Experts

A so-called “mixture of experts” operation can take an input vector and produce a selection vector corresponding in length to a list of “expert” models that each may respectively produce a prediction based on the input vector. The predictions can be aggregated into a weighted sum based on the weights produced by the weighting vectors, as given by [eq:34].

$$y = {\sum }_{i = 0}^{E} {g ( x )}_{i} \cdot {Expert}_{i} ( x )$$

When the mixture-of-experts operation is used in the transformer architecture, the feedforward residual block can implement the mixture-of-experts operation. For example, each expert in the mixture-of-experts can be a separate version of the feedforward block used. In some embodiments, each separate version of the feedforward block includes different feedforward parameters, such as given in [eq:7]. As a result, the mixture-of-experts operation can add additional parameters to the transformer architecture without increasing the computational effort involved, for example when a gating mechanism is associated with a sparsity.

For each expert i included in the mixture-of-experts, backpropagation and/or other training techniques can be used to compare the output value Expertᵢ(x) and determine the relative

weight g(x)ᵢ afforded that expert. In some implementations, the pruning of low-weighted expert models may be used to decrease the number of duplicate feedforward operations performed, while additional expert models may be generated and added to the mixture-of-experts operation based on the performance of the model.

### Properties of Recurrent ML Models

One advantage of transformers using the softmax self attention mechanism is the highly parallelizable nature of the transformer's computations. While the memory consumption and the computational effort may scale quadratically with the length of the input sequence using the softmax self attention mechanism, up to the size of performance resource constraint, this method may be desirably fast because of increased parallelization. Meanwhile, certain recurrent ML models that are able to approximate attention with a recurrent memory mechanism may suffer from a lack of parallelizability, which is not desirable. Thus, using an RNN, each timestep is computed sequentially and parallelization may be limited to parallelizing the memory matrix operations within a given timestep and to parallelizing across the output channels.

### Processing Multiple Elements in a Single Timestep (Parallelization)

Some inputs into an ML model may exclude a temporal component. For instance, patches that together comprise an input image are typically treated as separate tokens within an input sequence even though the image patches generally have no temporal order, since the input image is acquired at substantially one point in time. Non-temporal inputs may thus allow processing using a single timestep in which operations are parallelized.

### Batch Timestep

Multiple inputs may be processed in a single timestep (e.g., for parallel processing) to achieve the same result as if the multiple inputs had been processed in sequential timesteps. Computing read operations in parallel can be relatively simple. As soon as the state of memory matrix at timestep t, Wₜ, is ready, for example, the read output of element i in sequence S at time t can be computed using [eq:batch].

$${y}_{ti} = {W}_{t} {x}_{ti}$$

However, in contrast to the read operation, a write operation may introduce more complexity since multiple separate write vectors may overlap in respectively specified memory ranges. Accordingly, a parallelized write operation may involve an algorithm that satisfies certain additional criteria than given in [eq:34].
Single update consistency—If one update is made, the update should be equivalent to operation using a single element decoder.
Disjoint updates—If the key vectors in the update sequence are disjoint, the resulting update should be the equivalent of performing the same updates sequentially. As a result, a mean of the updates may be indicative of an incorrect outcome.
Minimize the effect of collisions on the final update ΔWₜ—If multiple updates are for the same location in the memory matrix, a weighted average can be used to produce an equivalent result to the multiple updates using a single update based on the weighted average.

In the following description, it can be assumed that the activation for φ(k) applies a normalization that keeps the length equal to 1 to simplify the respective expression. For an input sequence S with n elements, the state update in the memory matrix for element I without weighted averaging across elements is given by [eq:35] and [eq:36].

$$Δ {W}_{l} = ( {v}_{l} - W ϕ ( {k}_{l} ) ) ∘ σ ( {β}_{l} ) ⊗ ϕ ( {k}_{l} )$$

$$Δ {W}_{t} = {\sum }_{l = 0}^{n} Δ {W}_{l}$$

Two sources of weighting can be used to create a weighted average across the sequence:
1. The key vector φ(k); and
1. The gating vector σ(β).
   The weighted mean across the sequence for k can be computed as given by [eq:37].

$${ϕ ( k )}_{mean} = \frac{{ϕ ( k )}^{2}}{{\sum }_{l = 0}^{n} ϕ ( {k}_{l} )} or {ϕ ( k )}_{mean} = ϕ ( k ) ∘ \frac{{e}^{ϕ ( k )}}{{\sum }_{l = 0}^{n} {e}^{ϕ ( {k}_{l} )}}$$

The weighting aspect of the weighted average of k across a subsequence can be performed as softmax(φ(k)) across the subsequence as a mini-batch, but since the values of φ(k) are assumed to be positive, a similar value can be constructed without performing the exp( ) operation in [eq:37]. As a result, a weighted average can be created that ignores the gating mechanism, such as given by [eq:38].

$$Δ {W}_{l} = ( {v}_{l} - W ϕ ( {k}_{l} ) ) ◦ σ ( {β}_{l} ) ⊗ \frac{{ϕ ( {k}_{l} )}^{2}}{{\sum }_{i = 0}^{n} ϕ ( {k}_{i} )}$$

Furthermore, a weighted-mean of σ(β) can be computed using [eq:39].

$${σ ( β )}_{mean} = \frac{{σ ( β )}^{2}}{{\sum }_{l = 0}^{n} σ ( {β}_{l} )}$$

[eq:39] may allow the update timestep to utilize the gating mechanism to produce a weighting strategy, as given by [eq:40].

$$Δ {W}_{l} = ( {v}_{l} - W ϕ ( {k}_{l} ) ) ◦ \frac{{σ ( {β}_{l} )}^{2}}{{\sum }_{i = 0}^{n} σ ( {β}_{i} )} ⊗ ϕ ( {k}_{l} )$$

In some embodiments, [eq:40] can be split into two parts:
1. Direction mechanism: v₁−Wφ(kₗ); and
1. Weight mechanism: σ(β)⊗φ(k).
   The above approach may allow a given location along both the key dimension and the value dimension to receive an individual weighted averaging strategy, as given by [eq:41] and [eq:42].

$$\frac{{( σ ( β ) ⊗ ϕ ( k ) )}^{2}}{{\sum }_{l = 0}^{n} ( σ ( {β}_{l} ) ⊗ ϕ ( {k}_{l} ) )}$$

$$Δ {W}_{l} = \frac{( {v}_{l} - W ϕ ( {k}_{l} ) ) {σ ( {β}_{l} )}^{2} ⊗ {ϕ ( {k}_{l} )}^{2}}{{\sum }_{i = 0}^{n} ( σ ( {β}_{i} ) ⊗ ϕ ( {k}_{i} ) )}$$

In some embodiments, computing this update with sufficient accuracy may be computationally expensive, so an additional strategy approximates the same result by weighting each element individually, as given by [eq:43].

$$Δ {W}_{l} = ( {v}_{l} - W ϕ ( {k}_{l} ) ) ◦ \frac{{σ ( {β}_{l} )}^{2}}{{\sum }_{i = 0}^{n} σ ( {β}_{i} )} ⊗ \frac{{ϕ ( {k}_{l} )}^{2}}{{\sum }_{i = 0}^{n} ϕ ( {k}_{i} )}$$

Various mean operations in [eq:41], [eq:42], and [eq:43] can be replaced with a corresponding softmax mean function.

### Learning an Initial Memory Matrix W

The methods and systems disclosed herein may include an ability to learn an initial state of the memory matrix W, rather than initialize the memory matrix W to zero, which has been implemented in typical linear transformers that operate as RNNs and referred to as a learnable parameter Wₒ. The learnable parameter W can be used for integrating some optional configurations to replace feedforward residual blocks.

### Replacing Position Encoding

The focus mechanism described herein may exhibit improved performance when positional encodings are omitted. Accordingly, the methods and systems disclosed herein include embodiments that omit temporal positional encodings.

### Assembling the Model

### Attention Residual Blocks

### Learnable Parameters

Layer norm sublayer (normalization values are learnable)
W_{q}, Wₖ, Wᵥ, W_{β} projections for inputs to recurrent memory
Wₒ initial memory state
Replaced if initialized from another memory state recorded previously.
Size and shape of the memory state may vary if used in a multi-headed configuration.
W_{y} output projection from memory matrix.
b_{q}, bₖ, bᵥ, b_{β}, b_{y} optional biases for linear projections

### Implementation Details

The attention residual block according to the methods and systems disclosed herein can operate similarly to the typical attention residual block used in transformers. For example, the attention residual block according to the methods and systems disclosed herein can performs a normalization on the input, project the normalized input as output into the inputs of the RNN, perform the recurrent memory update, and query the memory matrix to obtain a next memory state, and then project the next memory state for the memory matrix onto the output of the RNN. Table 4 includes example pseudocode for the attention residual block according to the methods and systems disclosed herein, for single-headed attention.

TABLE 4
Attention Residual Block Example

```
def attention_block(x, W, W_q, W_k, W_v, W_beta, W_y, W_bias):
  x_norm = layer_norm(x)
  q = dot(x_norm, W_q)
  k = dot(x_norm, W_k)
  v = dot(x_norm, W_v)
  beta = dot(x_norm, W_beta)
  y = recurrent_memory(q, k, v, W)
  #update W
  output = dot(y, W_y)
  return x + output
```

### Feedforward Residual Blocks

In some embodiments of the methods and systems disclosed herein, typical feedforward residual blocks can be used. In particular embodiments of the methods and systems disclosed herein, the typical feedforward residual blocks may be replaced, omitted, or uniquely modified. For example, feedforward residual blocks may include many or most of the parameters in the ML model. However, when W is used to provide learnable parameters the memory matrix may replace some of the functionality of the parameters of feedforward residual blocks.
Channel mixing—the feedforward residual blocks may provide little to no advantage in mixing information across channels corresponding to neurons in the RNN. Even when multi-headed attention residual blocks are used, the output is projected onto the entire sequence.
Storing information in highly parameterized subnetworks with large dimensional space—the RNN mechanism can learn a memory state and may include a highly parameterized subnetwork that operates in a large dimensional space.
Storing and retrieving information sparsely—The mixture-of-experts method can be used for sparsification. The memory matrix used with RNNs can be fundamentally sparse, enabling retrieval of isolated information from the memory matrix.
Robustly keeping information available for processing—It has been demonstrated that, with a sufficiently large sparsity using mixture-of-experts, the ML model can prevent catastrophic forgetting during retraining, demonstrating that sparsity can help preserve information. Furthermore, by using sufficiently large sparsity in the memory matrix, robust retention of information can be achieved if important information retained or if certain existing data is overwritten with newer data that represents the same or similar information.
   Replacing Feedforward with Memory

Naively, the recurrent memory system can be a drop-in replacement for a parameterized mixture-of-experts feedforward block. The memory buffer may be able to learn a representation that would allow querying of a given RNN layer in a similar fashion, while the sparse query mechanism may perform multiple inference steps before stored information is overwritten. The memory buffer may add the advantage of being able to overwrite the data stored in a given RNN layer as new information becomes more relevant. However, the memory buffer may be subject to reduced robustness since all stored values may potentially be overwritten.

Replacing Memory with Sparsely Activated Feedforward RNN

Another option is to take a recurrent memory operation and to remove the write operation from the recurrent memory operation, which may allow operation as a mixture-of-experts feedforward residual block in an alternative implementation. The memory operation without write operations can increase the potential number of parameters the RNN can store, but the parameter information may be static after gradient descent optimization is completed, which can be desirable.

### Freezing Parameters in Memory

A recurrent memory operation that includes a write operation can be retained, but a mask can be applied to the write operation so that the parameters are prevented from being written or overwritten (e.g., frozen). Such a mask for retaining unmodified parameters can enable write operations and read operations from/to the memory matrix, while the frozen parameters are permanently determined by gradient descent.

To implement freezing parameters in memory, a mask vector m can be applied to the query used to construct the write operation, as given in [eq:49]

$$Δ W = \frac{( v - W ( m ◦ ϕ ( k ) ) ) ◦ σ ( β ) ⊗ ( m \cdot ϕ ( k ) )}{\sum {( m ◦ ϕ ( k ) )}^{2}}$$

The effect of [eq:49] can result in the write operation updating a submatrix in the memory matrix, while ignoring contents of the frozen weights (e.g., parameters) in other portions of the memory matrix. In this case, the query may effectively be given by q

$$y = {W}_{dynamic} ϕ ( q ) + {W}_{static} ψ ( q )$$

In other embodiments, the mask for freezing parameters in memory can be applied directly to the write operation as given by [eq:51].

$$Δ W = \frac{( v - W ϕ ( k ) ) ◦ σ ( β ) ⊗ ( m ◦ ϕ ( k ) )}{\sum m ◦ {ϕ ( k )}^{2}}$$

[eq:51] may exhibit the behavior of inserting v into W at k, while leaving static weights frozen.

The mask for freezing parameters can also be applied to the gating mechanism, such that the output channels have activations that remain constant as the memory matrix is updated, which may be preferable for being a simpler alternative.

Parallelization with Sparsity

### Computing Sparse Vectors

Computing the sparse vectors for every timestep can be prohibitively expensive. If an NN layer has as sparsity of 1/1000 and the sparse vector size is ^{˜}1\hat{ }6 (e.g., 1 million values), then every timestep may consume 1 million parameters worth of memory to represent a vector with a dense size of 2000 parameters (e.g., 1 parameter for values and 1 parameter for indices). The storage of excessive numbers of parameters in such a case can be mitigated by designing an operation that is capable of computing the sparse values and their indices, while omitting the intermediate parameter storage operation in memory, such as by using DPFP with a local_max sparsity operation. For example, the diagonal product can be computed in discrete windows to find the local_max product value in each window, along with the index of the parameter value. In the above example, a window size of 1000 may be compressed down into a single pair of sparse values, and can also be parallelized, which is desirable.

### Designing Sparse Matrix Computations

Generally, avoiding dense matrix multiplications on the scale of the methods and systems disclosed herein is desirable. For example, the sparsity of the RNNs may be between % and 1/10000, leading to a similar reduction in total computation. As long as the operations can be performed simultaneously in parallel, removing data density by adding sparsity may not necessarily improve inference speed. However, to obtain faster inference speed, a series of operations can be designed that take advantage of the desirable properties of sparse RNNs: sparse matrix computations with sparsity along the second to last dimension. In this manner, memory

matrix caching misses can be avoided when loading data, while still utilizing a sparse data pattern. For effective results, sparse matrix computations that support the pseudo-coded commands in Table 4 may be desirable.

TABLE 5
Sparse Matrix Computations

v = einsum(”...k,...kv−>...v″, k[i], W[i])
k[i] = einsum(″...kv,v−>...k″, W[i], v)
W[i] = einsum(”...k,...v−>...kv″, k[i], v)

The ability to perform a matrix multiplication between sparse vector k and non-sparse matrix W is desired, where the rows in W selected by indices from k are used to compute the output. Furthermore, operations that can sparsely compute the batched operations are desirable: the sum of k over the sequence dimension, and the sum of σ(β) over the sequence dimension can be useful for approximating the weighting mechanism.

### Memory Layouts

A memory matrix used for KEY_SIZE×VALUE_SIZE has been described, which can optimize against cache misses. However, this operation may be transposed. For example, assuming that temporal batching is applied in the sequence, the computation can be performed independently across both the batches and the values. The transposed operation may allow a kernel to be implemented that computes the RNN with a single scalar output value, iterating over the key dimension and the time dimension. The single scalar output value may perform optimally with a transposed VALUE_SIZE×KEY_SIZE memory layout, but may limit the parallelization to the batch size×number of value channels x the number of processors (e.g., workers) that can efficiently parallelize a timestep. Such an approach may be less efficient for inference time operations, so the memory may be transposed after pre-fill is completed.

### Gradients and Backpropagation

### Memory Mechanism

A memory write mechanism (without batching) for backpropagation can be given by [eq:52], [eq:53], and [eq:54].

$$\frac{\partial L}{\partial v} = ( \frac{\partial L}{\partial W} \cdot \frac{k}{\sum {k}^{2}} ) ◦ σ ( β )$$

$$\frac{\partial L}{\partial σ ( β )} = ( \frac{\partial L}{\partial Δ W} \cdot \frac{k}{\sum {k}^{2}} ) ◦ ( v - Wk )$$

$$\frac{\partial L}{\partial W} = \frac{\partial L}{\partial Δ W} - ( ( \frac{\partial L}{\partial Δ W} \cdot \frac{k}{\sum {k}^{2}} ◦ σ ( β ) ) \cdot k )$$

For ∂L/∂k, if the Euclidean length of k is exactly 1, then [eq:55] can apply.

$$\frac{\partial L}{\partial k} = ( ( v - Wk ) ◦ σ ( β ) ) \cdot \frac{\partial L}{\partial Δ W} - ( ( \frac{\partial L}{\partial Δ W} \cdot k ) ◦ σ ( β ) ) \cdot W$$

Otherwise, [eq:56], [eq:57], and [eq:59] can apply, while autograd can be used to compute the gradients for α.

$$α = \frac{k}{\sum {k}^{2}}$$

$$Δ W = ( v - Wk ) ◦ σ ( β ) ⊗ α$$

$$\frac{\partial L}{\partial k} = ( ( \frac{\partial L}{\partial W} \cdot α ) ◦ σ ( β ) ) \cdot W$$

$$\frac{\partial L}{\partial α} = ( ( v - Wk ) ◦ σ ( β ) ) \cdot \frac{\partial L}{\partial Δ W}$$

### Backpropagation Through Time

Because storing the memory state or memory state delta at every timestep for backpropagation may be prohibitively expensive in terms of computational cost, the memory state can be constructed for every timestep by storing an auxiliary value that is some function of the query of memory state W at time t, for example at given by [eq:60] and [eq:61].

$${v}_{aux} = Wk$$

$${W}_{t - 1} = {W}_{t} - ( v - {v}_{aux} ) ◦ σ ( β ) ⊗ k$$

When a weight matrix is multiplied by a sparse vector such as p(k), the multiplication operation can be performed sparsely. Such forward and backward operations can be performed with sparse matrix vector multiplications and sparse cross product addition operations.

### Feedforward Mechanism

Various adjustments can be made for different feedforward mechanisms.
Non-writing feedforward module: backpropagate through the read operation.
Write masked feedforward module: apply a mask aligned with the forward pass across the backward gradient calculations.

### Memory Locality

One desirable property of transformer architectures and linear recurrent operations in general is that the ML model is judicious about where information is stored. For example, if the ML model is ten layers deep, and a new piece of information or a new skill is received, the ML model stores the new data distributed across the network states of the ML model's layers. For example, if the ML model learns a new skill, such as addition, and stored critical information about completing this task in the third layer or higher, any new information or skills that rely on the concept, in this case addition, would be stored in the fourth layer or higher because the input features in lower layers would not contain representations relevant to the features of the new skill.

For example, when the RNN learns to arithmetically add on layer three, then the RNN can learn how to perform a matrix multiplication on layer four because matrix multiplication depends on addition and the RNN can extrapolate from being able to add from layer three to being able to add multiple times on layer four. Thus, dependent skills can be stored in a chain, leading to a capacity of the ML model to build on top of existing information being constrained by a depth of the RNN. As a result, in order to be able to build on learned concepts for a long period of time or indefinitely, the ML model may rely on a capability of migrating new skills to lower layers.

The capability of migrating new skills to lower layers may, in turn, rely on a feedback mechanism spanning multiple layers. Generation can be a unique capability of transformers that can span multiple layers, including into lower layers from higher layers, along with explicit feedback mechanisms that are not generalized. So, as the ML model generates new tokens, the ML model can express a skill that can be consumed by lower layers and used to update parameters of the lower layers to store an expression of the new skill. However, such generation for updating lower layers in the RNN may involve a certain amount of repetition.

Because of the recurrent nature of such an ML model design, a feedback mechanism allowing the activations in higher level layers to project and write onto the network state of lower-level layers may be substantially complex to implement with back propagation. The methods and systems disclosed herein may provide an RNN that performs feedback from higher layers to lower layers with a lower complexity than an RNN absent such non-adjacent layer feedback. the network state can be written to using arbitrary key/value pairs, a feedback mechanism is provided in which activations in higher-level layers can project and write onto lower-level layers.

### Multi-Layer Feedback

Within the ML model, feedback connections are trained and initialized to connect layer activations. The trained feedback connections can project the activations from higher layers onto a key value pair and use these to perform a write step on a lower layer or the same layer. Training can optimize trained feedback projections such that the resulting task better minimizes the loss function.

During a feedback phase, the RNN executes a timestep with sampled input. The sampled input is used to generate activations at each layer, as with a feedforward activation. Using the sampled input as the query produces the ML model's current network state. The RNN may then generate update projections to the network state. In some implementations, the training process may be repeated multiple times until the feedback phase is completed.

The input sampling may be performed with a number of methods. In some cases, the query tokens may be preselected to represent particularly learned feedback. Some or all of the tokens may be randomly generated within the space of possible tokens. The sampling may be autoregressively generated, using previous outputs to generate new inputs for the multi-layer feedback.

Different feedback methods may be performed during the feedback phase. In some implementations, feedback may use a pre-training model that runs an existing data set, such as a behavioral finetuning and inference dataset. This may be one of the datasets originally used to initialize the ML model or may be data selected for this phase specifically.

A feedback phase may, in some implementations, involve splitting a learned task into multiple portions such that the information or demonstrations in the earlier portions inform the dataset for the later portions.

A feedback phase may, as described above, use gradient descent to train the ML model. One or more feedback steps are performed between two phases of each task, allowing for an update to the parameters of the feedback method. The losses computed over the second half of the task are then computed after the feedback phase.

In some implementations, an audit may be performed following a feedback update to ensure that, for components of the task after the update, there is an improvement (that is, a lower calculated loss) than prior to application of the feedback. The system may partially or fully revert any changes due to feedback that remains unverified as an improvement.

In some implementations, during an inference process, feedback steps can be performed at selected or sampled locations. Localized feedback may consume fewer resources than full-system feedback, while targeted updates can maximize the impact of feedback phases.

### Training the Model

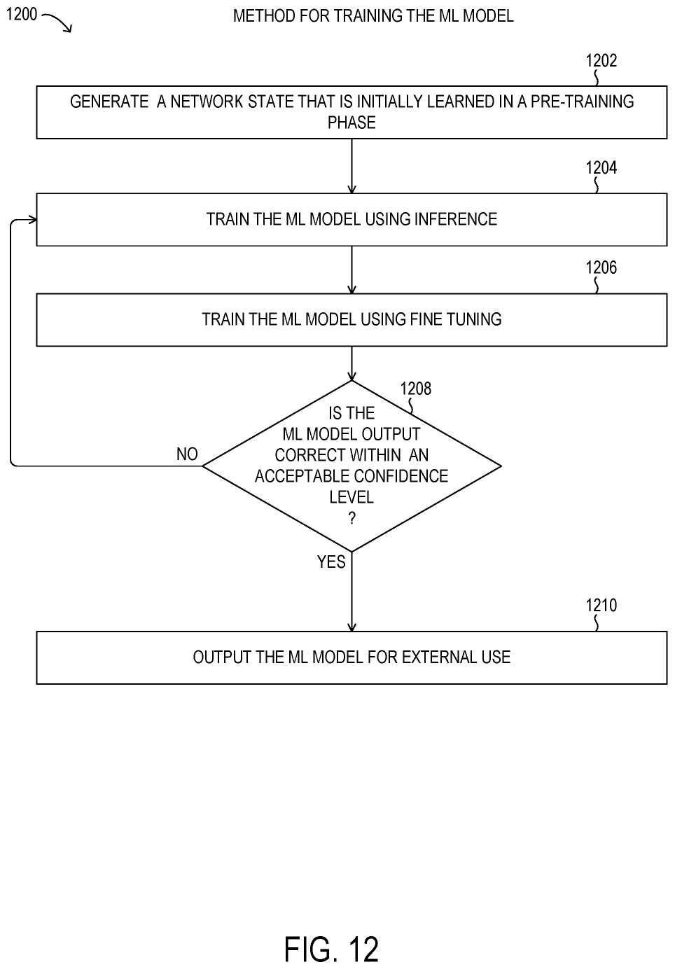

FIG. 12 is a flow chart of a method 1200 for training the ML model. It is noted that certain operations described in method 1200 may be optional or may be rearranged in different embodiments. The ML model may be trained iteratively through several different phases, as illustrated in method 1200.

Method 1200 may begin at step 1202, by generating a network state that is initially learned in a pre-training phase. At step 1204, the ML model is trained using inference. At step 1206, the ML model is trained using fine tuning. At step 1208, a decision is made whether the ML model output is correct within an acceptable level of confidence. When the result of step 1208 is NO, method 1200 loops back to step 1204. When the result of step 1208 is YES, method 1200 proceeds to step 1210 by outputting the ML model for external use.

### Pre-Training Phase

The pre-training phase, represented as step 1402 in FIG. 14, generates a working model from a pre-training data set. Here, the initial state space (which may solely or largely contain “null” or default values) is repeatedly modified using gradient descent to approximate a working model.

The optimal model parameters are selected based on metrics described herein, which may include retention performance, reduction in loss function, and accurate reproduction of the pre-training dataset. Additionally, the optimal initial memory may be evaluated based on its ability to generate media with the intended modalities and organize information to perform pre-training generation tasks.

Input and output modalities can be different. Input modalities may be passed as inputs to the RNN, but they may be generated outside the RNN. In a first example, an optical character recognition (OCR) task can be learned: an ML model may take an image as an input and be tasked with generating the text in the image as text. In the first example, the input modality may be both image and text (text is included because the preceding tokens that might direct the network to complete an OCR task based on the image would represent past generations when generating the next token). A second example may be an image generation task with a text prompt: the ML network is given a text prompt and is tasked with iteratively generating a less noisy image as a diffusion task. In the second example, the input modality is text. Input modalities can be independent of generation tasks within the pre-training dataset but can be located at the beginning or middle of multi-modal sequences.

Output modalities may be tied to information that can be generated. In the pre-training phase, the ML model produces an error signal based on an ability to perform generation tasks: text generation, image generation, neural radiance fields (NeRF), audio generation, etc. The utilized output modalities may involve a generation task within the pre-training dataset to support certain modalities.

For an output modality, generation tasks can be included in the pretraining dataset. While generation tasks may cover less than a full range of tasks that the model is tasked to perform, generation can cover a spectrum of expected behaviors so that downstream learning and retention can store information that interpolates from what is represented in the pretraining dataset. The pretraining dataset can be curated to represent a wide range of domains with bias towards high quality content. The pretraining dataset may contain tasks that involve the ML network learning and retaining information for large spans of timesteps, whereby retaining information indefinitely is something that the ML network can to learn how to do.

The pre-training phase can be differentiable so the ML network can be optimized via a gradient descent algorithm. Similar to transformer models, the pre-training phase can apply the gradient descent algorithm to iteratively optimize the ML model on the pretraining dataset, compute a loss for what is generated at every training step, and compute an update to the parameters of the ML model. The pre-training can train both the normal parameters of the ML model as well as the initial memory state Wₒ.

Different from normal sequence model optimization, the pre-training phase can maintain a population of W values, sampling W values for each optimization step. New memory states generated by inference may be added to the population or used to initialize subsequent training steps.

### Inference Training Phase

Once pre-training has completed and the RNN has learned how to organize information, the RNN can be trained through an inference dataset, represented as step 1404. The goal of inference training can be to give the ML model a series of experiences in which the ML model produces a new Wₒ as the result of the inference. In other words, an update to the memory parameters is generated based on the input and learned dynamics of the ML model. An inference training dataset can be constructed storing the information that the ML model can store. The length or modality of the records in inference training dataset can be unconstrained, as long as the ML model was pre-trained using the inference training modalities as an input. With sufficient memory size, and an ML model of sufficient quality, the ML model may be capable of memorizing the inference training dataset and encoding the inference training dataset as explicit experiences within the ML model's context. Repetition (scoring over multiple epochs) may be used to reinforce the information in the inference training dataset.

### Learning Through Media Consumption

One advantage of inference training for learning can be that the ML model can robustly learn information even if the ML model is untrained to generate the learned content. For example, an ML model trained to consume images containing text as an input but untrained to generate images could learn tasks and facts from images of pages simply by consuming the images at inference time.

### Learning Through Exploration

The ML model can interact with a constructed environment by consuming observations, generating actions, and consuming subsequent observations in response to the actions generated. This kind of interaction may be performed by using a computer via command line, or interacting with a reinforcement learning gym environment, or interacting with a human in a chat interface. While the ML model may avoid explicitly performing reinforcement learning, the ML model may be able to observe the dynamics of the environment and update the ML model's knowledge of the environment through retained learning of the experience.

### Crafting Inference Skills

Similar to prompt engineering to instill an ML model with a novel skill during inference context, a dataset of skills can be used to train the ML model during an inference training phase. The dataset of skills can include documentation of a downstream tool that the ML model has access to along with a robust set of examples. The dataset of skills can include a large dataset of demonstrations of applying a skill (such as navigation of an environment in one example), or another way that a skill may be taught. Thus, instead of limiting the skills to a handful of skills that may be used in a single context, various aspects related to a skill can be included in the dataset of skills used during this training phase.

### Compressive Learning Through Feedback

In order to consolidate inference time learning with compressive learning over very long sequences, a feedback mechanism can be incorporated into the inference training phase.

### Repetition as an Alternative to Feedback

While repetition may avoid explicitly compressing learning into lower RNN layers, the fact that all of the layers have already been conditioned on all of the data of the sequence can create opportunities for more efficient and earlier storage of compressive representations, especially since skills and knowledge that build on each other are accessible simultaneously at every layer.

### Feedback Via Generation

A weak signal of generation can be used to produce compressive representations of the contents in lower layers. After a piece of media or instruction is introduced to the ML model, the ML model can be prompted to generate an explanation or chain of thought process to express an understanding of the media. The generated explanation can act as a probe, querying the information stored in the upper layers of the RNN relevant to the recent media and presenting the information explicitly as an input to the lower layers of the network.

### Explicit Feedback Method

The methods and systems disclosed herein provide an explicit feedback method that may allow higher level layers to write explicitly to lower-level layers of an RNN. While the high-to-low feedback may be difficult to train via gradient descent, the high-to-low feedback may have a small or negligible impact on inference mode computations and may be utilized after each token. The explicit feedback method may also describe a probing mechanism that allows feedback to be performed at designated timesteps.

### Learning Via Human Interaction

The methods and systems disclosed herein may include a dynamic interface for reading the output of the ML model by a human, and for the human to provide responses, guidance, criticism, or instruction back to the ML model. In the context of performing a data entry task, a human may observe the data entry constructed by the ML model, identify whether the data entry contained any errors, and offer additional instruction on how to perform the task correctly.

### Asynchronous Inference

The inference training process may be linear, such that each consumed piece of media arrives after a previous piece of media. In order to accelerate the acquisition of knowledge by consuming media in parallel the methods and systems disclosed herein may include the following methods.

In some implementations, a plurality of diverging agents may be initialized in parallel. Each diverging agent may apply the model parameters to a different portion of the dataset. Although initialized with the same network state, each agent will have differing parameters from the others as the agent is further trained during inference activation.

After some number of phases or steps in parallel, some or all of the agents are merged. Differing mechanisms are possible for the merging process, including the combination of separately computed input vectors.

FIG. 13 is a depiction of an RNN process 1300 using agents that is capable of at least some parallel processing. RNN process 1300 is a schematic depiction and may be rearranged in different embodiments. RNN process 1300 is shown using 4 parallel agents (represented by respective 4 parallel processing paths in FIG. 13) for descriptive clarity, while it will be

understood that different numbers of parallel agents, including large numbers or very large numbers of agents, can be used in different embodiments. Although described with respect to an RNN, it is noted that the methods and operations described below with respect to FIG. 13 and the parallel agents can be implemented in various types of NNs including an RNN.

At 1302, a plurality of agents is initialized. Each agent may represent all or a portion of the parameters of the network state. Some randomizations may be introduced in the agents, or the agents may initially be identical copies of the ML model. At 1304, each of the agents undergoes separate training and modification through inference passes on some portion of the network state. The input data used for each agent may be the same, partially the same, or entirely disjoint. As shown in FIG. 13, one processing stage 1304 is shown in a simple example for descriptive clarity. It is noted that multiple stages can be used in various embodiments. In other embodiments, an iterative process, as described above with respect to repeated training and/or autoregression, may be practiced using the individual agents. The repeated training passes can occur in parallel, such as by using individual agents in parallel. In some embodiments, queuing, threading, and other procedures of the digital environment may be performed sequentially by at least some agents in real-time.

At 1306, an agent update tensor is computed for each agent. The agent update tensor may take a variety of forms, such as an update mask over the locations in memory to be altered, or a set of change values representing the difference between the initialized and finalized memory value.

At 1308, the agents update tensors are combined into an update tensor that is output from process 1300. Combining the update tensor in 1308 may use a weight computation, such as the σ(β) and φ(k) vectors for each agent as described above. The maximum or sum of the vector bases may be used to compute the combined vector. Alternatively, a weighted mean may be used. In certain implementations, an optimizer, such as a gradient descent optimizer, may be used to process the input data and to calculate the individual tensors. In various embodiments, an overall gradient can be generated by combining calculated gradients, such as based on differences between a prior agent state and a current agent state.

In particular embodiments, RNN process 1300 may employ a processing algorithm to coordinate the agents, such as to process the input to the RNN and to combine respective computed

states of the agents (e.g., agent states) into a single network state. The processing algorithm may include initialization to optimize the network state of the ML model. A current network state can be sent by the processing algorithm to some or all of the agents. Each of the agents may have an internal memory state that can be initialized with a memory state received by the processing algorithm. Then, each of the agents may operate over some sequence (e.g., over some number of sequence steps) to generate a new agent state. The new agent states may be used to compute an equivalent to a gradient, such as by calculating a difference between a prior memory state and the new memory state. In this manner, the gradient (or difference) can then be used by the processing algorithm to compute an update to the network state. As the processing algorithm performs more sequence steps, each sequence step updates the network state used for initializing the agents when the next sequence is received.

A memory combination system can be used to coordinate the agents and combine agents' computed states into the network state (e.g., a single state). For example, the memory buffers of multiple diverging agents can be combined using various methods, such as by computing a sum of differences from the initial state, as given by for one agent.

$$Δ W = \sum f ( {W}_{i} , sequence ) - {W}_{i}$$

A mean representation of the sum in equation 62 for n number of agents is given by [eq:63].

$$Δ W = \frac{{\sum }_{i = 0}^{n} f ( {W}_{i} , sequence ) - {W}_{i}}{n}$$

Furthermore, particular embodiments of RNN process 1300 may utilize a weighting mechanism that can approximate combining multiple write operations (e.g., from respective agents) into a single write operation. The weighting mechanism may be approximated by RNN process 1300 by computing certain statistics associated with at least some values stored in the memory state at specific locations, or statistics associated with all values in the memory state in some embodiments. The weighting mechanism may compute a weighting parameter based on certain criteria, such as whether a parameter was modified, or an operation over the combination of weighting parameters used to compute the updates, such as a key component, a beta component, or some combination or aggregation thereof.

The memory states for each respective agent n can then be combined using [eq:64] and [eq:65].

$${W}_{new} , {W}_{weight} = f ( W , sequence )$$

$$Δ W = {\sum }_{i = 0}^{n} ( {W}_{new , i} - W ) ◦ \frac{{w}_{weight , i}}{{\sum }_{j = 0}^{n} {w}_{weight , j}}$$

As a result, the following properties of RNN process 1300 may be realized:
when a parameter was modified by one agent, a new value for the parameter can be directly integrated into a new memory state; and
when a parameter was modified by multiple agents, a new value for the parameter can be resolved using a weighted average over the multiple agents.
   In summary, using RNN process 1300, a merge of memory states can be performed, where the deltas from the resulting (e.g., updated) memory states are separate gradients.

In some embodiments of RNN process 1300, the processing algorithm described above may be implemented using an optimizer that includes certain tensor functionality, such as automatic calculation of certain mathematical properties, such as momentum, derivatives, mean, variances or other statistical values. In particular embodiments, the processing algorithm or the optimizer used for RNN process 1300 can include a gradient descent optimizer.

### Behavioral Finetuning Phase

Behavioral finetuning is a known aspect of generative language model training, with algorithms such as reinforcement learning from human feedback (RLHF) and low rank adaptation (LoRA). Behavioral finetuning training techniques can be applied to the ML model. In some embodiments, behavioral finetuning training that is stored inside of a W parameter may be overwritten at inference time.

### Preventing Expiration of Behavioral Learning

It may be undesirable to overwrite behavioral finetuning for safety or other reasons. For this reason, a mechanism to prevent learned information from being overwritten during normal memory operations may be used.

One or more portions of data, customarily designated “channels” within the memory state, may be exempt from modification during inference. These channels may be optimized during finetuning phases but may remain blocked from being written during inference phases.

Supplemental training structures may also be applied to preserve behavioral learning over time. A secondary support model may have loss functions that closely adhere to certain behavioral tasks and are available to curtail or reverse undesired modifications to learned information.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A computer-implemented method for approximating a linear attention mechanism in a chunkwise manner, the method comprising: maintaining, in memory, a matrix-valued state; receiving a chunk comprising, for each input, a key vector, a value vector, a gate parameter that is a scalar or a vector, and optionally an independent per-input control value, and further including a set of query vectors; for each input in the chunk: computing an error as a difference between the value vector and a product of the state and the key vector; multiplicatively applying the gate parameter to the error, element-wise when the gate parameter is vector-valued, to obtain a gated error; and forming an update proposal as a rank-1 outer product of the gated error and the key vector; reconciling, at each coordinate of the state, the update proposals into a chunk update by computing per-coordinate non-negative coefficients over the set of update proposals such that (i) when exactly one proposal contributes at that coordinate the coefficient for that proposal equals one and the others equal zero, and (ii) when two or more proposals contribute at that coordinate the coefficients sum to one, thereby yielding a value within the convex hull of those proposals; and updating the state with the chunk update; and for each query vector, producing an output vector using the state.

2. The method of claim 1, wherein the forming of the update proposal further comprises dividing the gated error by a squared Euclidean norm of the corresponding key vector.

3. The method of claim 1, wherein coefficients used by the combining operator are derived solely from the key vectors of the inputs in the chunk.

4. The method of claim 1, wherein coefficients used by the combining operator are derived solely from the gate parameters of the inputs in the chunk.

5. The method of claim 1, wherein coefficients used by the combining operator are jointly derived from the key vectors and the gate parameters of the inputs in the chunk.

6. The method of claim 1, wherein coefficients used by the combining operator are derived solely from an independent per-input control value associated with each input in the chunk.

7. The method of claim 1, wherein the coefficients used by the combining operator are derived from pairwise dot products among the key vectors within the chunk.

8. The method of claim 1, wherein the coefficients used by the combining operator are effected implicitly by transforming one or both of the key vectors and the gate parameters prior to forming the update proposals such that the resulting proposals, when combined, yield the same per-coordinate result as would explicit coefficients.

9. The method of claim 1, wherein producing the output vectors comprises evaluating dot products between the query vectors and the key vectors in the chunk and linearly combining the value vectors according to the coefficients used by the combining operator, without first storing an updated state.

10. A system comprising one or more processors and a memory storing instructions that, when executed by the one or more processors, cause the system to perform the method of claim 1.

11. A non-transitory computer-readable medium storing instructions that, when executed by one or more processors, cause performance of the method of claim 1.

12. A computer-implemented method comprising: (a) maintaining, in memory, a state tensor for a recurrent neural network (the “state”); (b) initializing a plurality of agents with a common initial state and running each agent along a trajectory that is a sequence of inputs and timesteps beginning at the common initial state; (c) for each agent, obtaining an update that specifies, for one or more addresses of the state, a per-address numeric delta to be applied to the state, and obtaining a corresponding coefficient for the agent provided as a scalar, vector, or tensor, the coefficient being supplied by the agent or computed by a coordinator from agent-specific signals, and being replicated across one or more dimensions to align in shape with the agent's update when shapes differ; (d) assembling a merged update by, for each address (a position in the state tensor): (i) when exactly one agent provides a non-zero update at the address, setting the merged contribution equal to that update; and (ii) when two or more agents provide non-zero updates at the address, combining the agents' per-address updates in accordance with their coefficients to produce a single per-address delta; (e) when exactly one agent provides a non-zero update at the address, setting the merged contribution equal to that update; and (i) when two or more agents provide non-zero updates at the address, combining the agents' per-address updates in accordance with their coefficients to produce a single per-address delta; (f) updating the state by applying the merged update to produce an updated state for subsequent processing; and (g) performing steps (c)-(e) at a coordination step of a processing algorithm that collects updates from the plurality of agents and combines them.

13. The method of claim 12, wherein each agent's coefficient is aggregated over the agent's trajectory and is provided per address of the state.

14. The method of claim 12, wherein each trajectory provides updates for a subset of addresses of the state and addresses not provided in a trajectory are treated as zero updates for that trajectory when assembling the merged update.

15. The method of claim 12, wherein the combining in step (d) for an address at which two or more agents provide non-zero updates is order-invariant, such that the merged contribution at the address is independent of the processing order of agent updates.

16. The method of claim 12, wherein the combining in step (d)(ii) is convex-hull constrained, such that the merged contribution at the address lies in the convex hull of the agents' updates at that address.

17. The method of claim 12, wherein the combining in step (d)(ii) comprises one of: (a) a normalized weighted sum in which each agent's contribution is the agent's update at the address multiplied by a coefficient divided by the sum of coefficients provided for that address when that sum is non-zero; a weighted median computed from the agents' updates at the address using their coefficients; or (b) a max-basis selection that selects the update associated with an extremal coefficient at the address.

18: The method of claim 12, wherein each coefficient is monotone with respect to an overwrite-strength measure at an address, the overwrite-strength measure being a real-valued function of an agent's trajectory and state interaction that satisfies: (a) monotonicity: if an agent increases its overwrite effect at an address, the measure does not decrease; (b) zero at no-write: the measure is zero when the agent supplies only zero updates at the address; and (c) equalization at full-overwrite: two agents that fully overwrite the address according to the measure receive equal coefficients at that address.

19. The method of claim 18, wherein the overwrite-strength measure comprises at least one of: (a) a cumulative write-gate mass at the address computed over the trajectory; (b) a residual-reduction norm ∥v−Sk∥ aggregated over writes at the address; or (c) a bounded, saturating transform φ(m) with φ(0)=0 and lim_{m→∞}φ(m)=C>0, used to derive the coefficient from a raw measure m.

20. The method of claim 12, wherein updates and coefficients are sparse over addresses and represented by explicit index lists, and the addresses are optionally block-sparse or hierarchically addressed.

21. The method of claim 12, wherein the merged update of step (d) is applied directly to the state without preprocessing by an optimizer.

22. The method of claim 12, further comprising preprocessing the merged update produced in step (d) by an optimizer to produce a transformed update, and applying the transformed update to the state in step (e).

23. A system comprising: one or more processors; and a memory storing instructions that, when executed by the processors, cause the processors to perform the method of claim 12.

24. A non-transitory computer-readable medium storing instructions that, when executed by one or more processors, cause the processors to perform the method of claim 12.

25. A computer-implemented method comprising: maintaining, for a neural network having at least a lower recurrent layer and a higher recurrent layer, a recurrent state for each layer; during processing of a timestep, obtaining a feedback activation produced by computation that executes after the lower layer within the same timestep and is computationally dependent (directly or indirectly) on an output of the lower layer; computing, by a feedback projection with learned parameters, an update to the recurrent state of the lower layer based at least on the feedback activation; and applying the update using a state-update operation of the lower layer to modify its recurrent state such that computations of the lower layer at a subsequent timestep are conditioned on the modified state; wherein “higher” and “lower” are defined by execution order within a recurrent timestep, and a “higher” layer (or process) depends on the lower layer's output for that timestep.

26. The method of claim 25, wherein the update comprises, for each input element, a key tensor and a value tensor, and optionally one or more per-element control tensors sufficient to parameterize the state-update operation of the lower layer.

27. The method of claim 25 or 26, wherein after completing timestep *t* and before beginning timestep *t+1* of the same sequence, the neural network temporarily pauses ingestion of new inputs, and generates and applies the update(s) as a batch of one or more updates during that interval.

28. The method of any of the claims 25-27, wherein the feedback activation is sampled from one or more activations of a higher-level recurrent process, the higher-level recurrent process being one that at each timestep consumes, directly or indirectly, the output of the lower recurrent layer for that timestep.
